(19) United States
(12) Patent Application Publication
(10) Pub. No.: US 2019/0310643 A1
(43) Pub. Date: Oct. 10, 2019

(54) APPARATUS, METHOD AND PROGRAM FOR STEERING ASSIST OF SAILBOARD

(71) Applicant: FUJITSU LIMITED, Kawasaki-shi (JP)

(72) Inventor: SHINYA YOKOI, Kawasaki (JP)

(73) Assignee: FUJITSU LIMITED, Kawasaki-shi (JP)

(21) Appl. No.: 16/377,432

(22) Filed: Apr. 8, 2019

(30) Foreign Application Priority Data
Apr. 10, 2018 (JP) 2018-075761

(51) Int. Cl. G05D 1/02; G05D 1/00

(52) U.S. Cl. CPC G05D 1/0206; G05D 1/0044

(57) ABSTRACT

A steering assist system for a sailboard includes on-board steering assist apparatus and an information processing apparatus. The information processing apparatus specifies a recommended movement direction or a recommended sail direction, based on a movement direction and a movement speed with reference to a movement history of the sailboat, and transmits it to the on-board steering assist apparatus. The on-board steering apparatus receives the recommended movement direction or the recommended sail direction, and display it.

### CROSS-REFERENCE TO RELATED APPLICATION

This application is based upon and claims the benefit of priority of the prior Japanese Patent Application No. 2018-75761, filed on Apr. 10, 2018, the entire contents of which are incorporated herein by reference.

### FIELD

The embodiment discussed herein is related to a steering assist program, a steering assist method, and a steering assist apparatus.

### BACKGROUND

Generally, it is said that the quality of sailing of a moving body that is moved by wind, such as a sailboard, depends on the board speed and sailing angle (an angle between the travel direction of the board and the wind). A good sailing form to efficiently catch wind is that the mast is upright and the sail is stable. When the mast moves back and forth and right and left or the sail is not pulled sufficiently, the flow rate of wind blowing to the sail changes. The wind therefore escapes, resulting in power reduction. This can reduce the speed or increase the fatigue of the rider. Training of the form to solve the aforementioned problem and improve the steering skill is performed by repeatedly taking moving images of sailing performed on the ocean with a camera from the shore and replaying the taken moving images for confirmation.

As related prior arts, a technique to calculate a correct sail position from information on the vessel speed and the wind direction and speed, a technique to set the boom angle to an optimal operation position in relation to the wind direction, and a technique to calculate the azimuth of the sailing direction from the sailing angle at a wind speed, which is determined based on the wind speed, and the wind direction are disclosed.

Related techniques are disclosed in, for example, Japanese Utility Model Laid-open Publication No. 62-146699, Japanese Patent Laid-open Publication Nos. 8-216987, and 2016-74236.

Trainings of sailboards, such as windsurfing boards, are often performed on the ocean off the shore. In the conventional training methods, data is obtained only from videos taken by cameras and the like and is limited. In terms of the cost for trainings, there is a demand for the person who trains to check the form for him/herself. Windsurfing is a sport handling invisible “wind”, and the optimal sailing form itself has not yet been defined.

An object of an aspect of the disclosure is to assist efficient steering and sailing.

### SUMMARY

According to an aspect of the embodiments, a steering assist system for a sailboard includes on-board steering assist apparatus and an information processing apparatus. The information processing apparatus specifies a recommended movement direction or a recommended sail direction, based on a movement direction and a movement speed with reference to a movement history of the sailboat, and transmits it to the on-board steering assist apparatus. The on-board steering apparatus receives the recommended movement direction or the recommended sail direction, and display it.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view illustrating a system configuration example of a sailing training assist system;

FIG. 2 is an explanatory view illustrating a hardware configuration example of a sensor.

FIG. 3 is a flowchart illustrating a recording procedure example of the sensor;

FIG. 4 is an explanatory view illustrating a GPS value format example;

FIG. 5 is an explanatory view illustrating a format example of a 9-axis sensor;

FIG. 6 is a flowchart illustrating a data acquisition procedure example of the 9-axis sensor;

FIG. 7 is an explanatory view illustrating a format example of data acquired by the sensor;

FIG. 8 is a flowchart illustrating a procedure example to register data in a database;

FIG. 9A is an explanatory view illustrating a hardware configuration example of an information processing apparatus according to the embodiment;

FIG. 9B is an explanatory view illustrating a hardware configuration example of a steering assist apparatus according to the embodiment;

FIG. 10A is a block diagram illustrating a functional configuration example of the information processing apparatus according to the embodiment;

FIG. 10B is a block diagram illustrating a functional configuration example of the steering assist apparatus according to the embodiment;

FIG. 11 is a flowchart illustrating a procedure example to display data;

FIG. 12 is an explanatory view illustrating classification of sailing data;

FIG. 13 is a flowchart illustrating a procedure example to calculate angle data;

FIG. 14 is an explanatory view illustrating calculation of pitch angle;

FIG. 15 is an explanatory view illustrating calculation of roll angle;

FIG. 16 is an explanatory view illustrating calculation of yow angle;

FIG. 17 is an explanatory view (Part 1) illustrating contents of data display;

FIG. 18 is an explanatory view (Part 2) illustrating contents of data display;

FIG. 19 is an explanatory view (Part 3) illustrating contents of data display;

FIG. 20 is an explanatory view (Part 4) illustrating contents of data display;

FIG. 21 is an explanatory view (Part 5) illustrating contents of data display;

FIG. 22 is an explanatory view (Part 6) illustrating contents of data display;

FIG. 23 is an explanatory view (graph) illustrating the way to determine width and color of a VMG region; and

FIG. 24 is an explanatory view (graph) illustrating the way to determine color for angular expression.

### DESCRIPTION OF EMBODIMENTS

Hereinafter, a description is given of an embodiment of a steering assist program, a steering assist method, a steering assist apparatus, and an information processing apparatus according to the disclosure in detail with reference to the drawings.

### Embodiment

(System Configuration Example of Sailing Training Assist System 100)

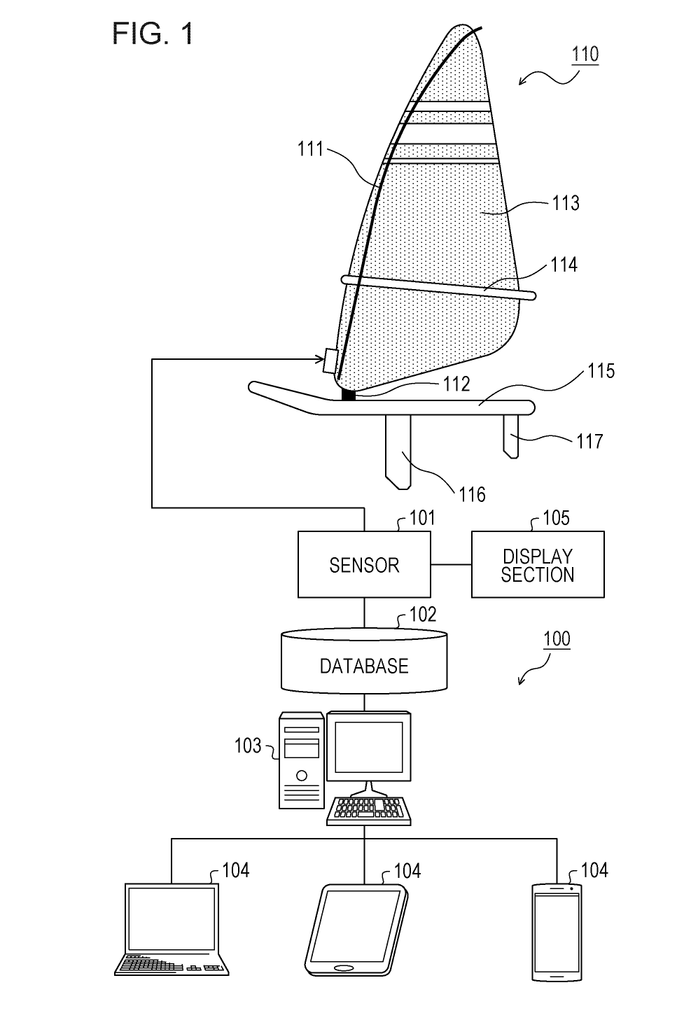

FIG. 1 is an explanatory view illustrating a system configuration example of a sailing training assist system. In FIG. 1, a sailing training assist system 100 includes a sensor 101, a database 102, an information processing apparatus 103, and a steering assist apparatus 104.

FIG. 1 illustrates a windsurfing board 110 as a target of sailing trainings. The windsurfing board 110 is a sailboard example which is a moving body moved by wind. The windsurfing board 110 moves on the surface of water by a rider maneuvering a dedicated tool including a board 115 with a rig attached thereto (hereinafter, this dedicated tool is sometimes referred to as a sailboard 110 or a windsurfing board 110).

The rig includes a mast 111, a joint 112, a sail 113, and a boom 114. The rig is attached to the board 115 with the joint 112. The board 115 includes a daggerboard 116 and a fin 117.

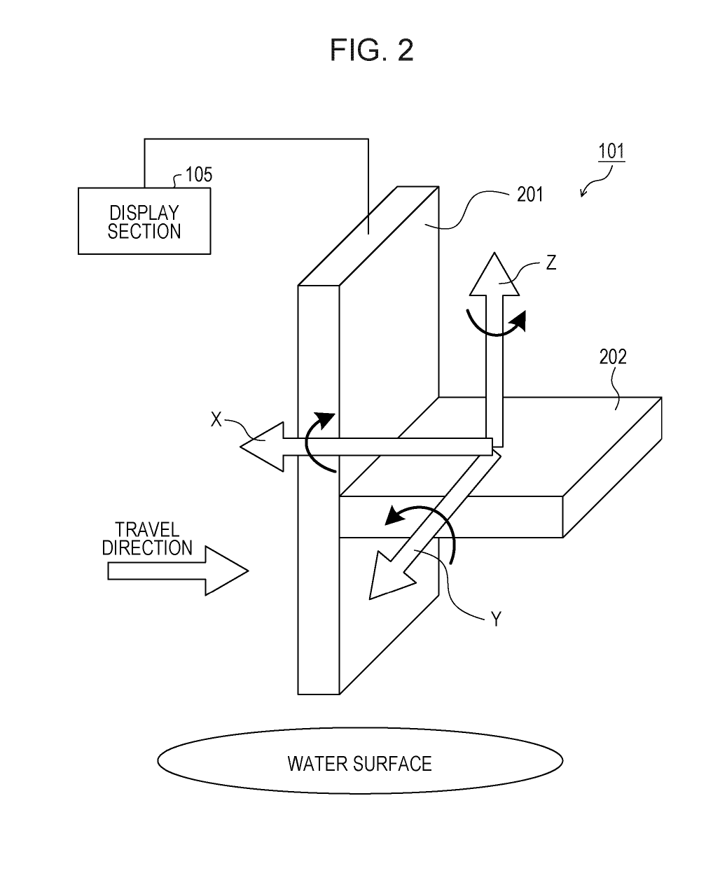

The sensor 101 is attached to lower part of the mast 111 near the board 115. The sensor 101 includes a display section 105. The details, including attachment of the sensor 101 to the mast 111, are described later using FIG. 2 and the like.

In the sailing training assist system 100, the sensor 101 and database 102 are not connected directly. Data acquired by the sensor 101 is stored in the database 102 through a not-illustrated recording medium such as an SD card, for example. Alternatively, the sensor 101 and database 102 may be connected through wireless communication. The sensor 101 and database 102 may be connected through a not-illustrated wired or wireless network.

In the sailing training assist system 100, the database 102 and information processing apparatus 103 are connected through a not-illustrated wired or wireless network. The network may be the Internet, a mobile communication network, a local area network (LAN), a wide area network (WAN), or the like, for example. The database 102 may be implemented by a not-illustrated cloud server. The database 102 may be provided for the information processing apparatus 103.

The sensor 101 acquires positioning information concerning the location of the windsurfing board 110 and information concerning the state of the sail 113. The database 102 stores the information acquired by the sensor 101. The information processing apparatus 103 displays various information for assisting sailing trainings based on the information stored in the database 102.

The information processing apparatus 103 is a computer used by a user of the sailing training assist system 100. The information processing apparatus 103 may be implemented by a cloud server connected to a network.

The steering assist apparatus 104 is a computer used by the user of the sailing training assist system 100. Specifically, the steering assist apparatus 104 may be implemented by a personal computer, a tablet terminal device, a smartphone, or the like, for example. The steering assist apparatus 104 may be an information processing apparatus installed on the sailboard 110. In this case, the steering assist apparatus 104 is attached to such a position that the steering assist apparatus 104 does not influence steering of the sailboard 110 while the rider is able to see the steering assist apparatus 104 or is able to hear the sound outputted from the steering assist apparatus 104. The steering assist apparatus 104 may be worn on the rider's body instead of or in addition to being installed on the sailboard 110. Specifically, the steering assist apparatus 104 may be a wearable device such as a watch-type, goggle-type, or earphone-type device.

(Hardware Configuration Example of Sensor)

FIG. 2 is an explanatory view illustrating a hardware configuration example of the sensor. In FIG. 2, the sensor 101 has a configuration including a base 201 and a 9-axis sensor 202 (specifically, a 9-axis inertial measurement unit). The sensor 101 is connected to a display section 105.

The 9-axis sensor 202 is provided for the base 201 which is attached to the mast 111 so as to extend vertically to the surface of water and parallel to the travel direction. The base 201 includes a GPS receiver. The sensor 101 simultaneously records GPS data (data representing sailing conditions: speed and travel direction) and data from the 9-axis sensor 202 (data representing the sailing method: three-dimensional sail operation). The sail operations (tilting the mast 111 forward, backward, rightward, and leftward and rotating the mast 111) are recorded by detecting rotation angles of the 9-axis sensor 202 in the X, Y, and Z directions.

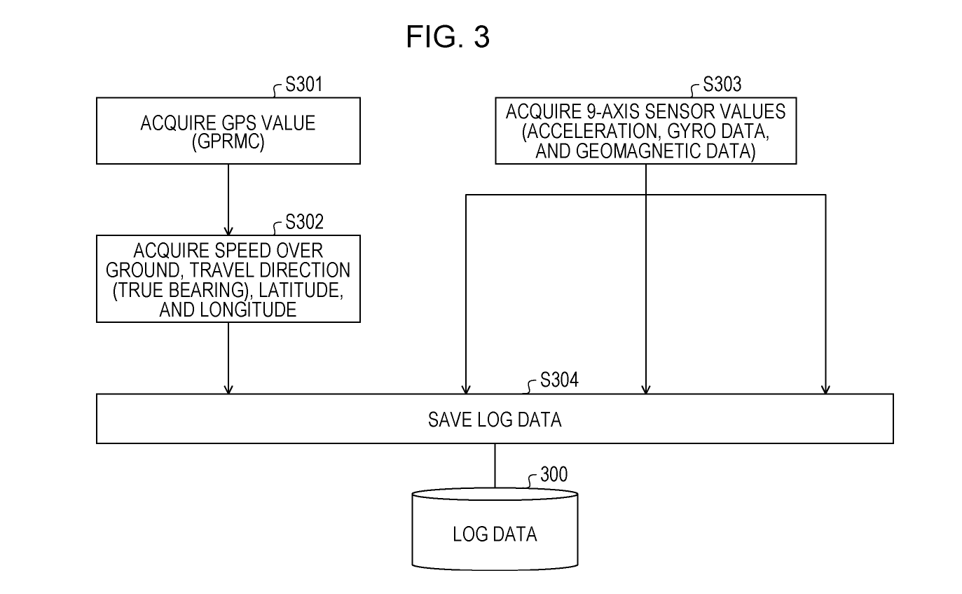

FIG. 3 is a flowchart illustrating a sensor recording procedure example. In the flowchart of FIG. 3, the sensor 101 acquires a GPS value (GPRMC) indicating the current location (step S301). Specifically, the sensor 101 acquires the GPS value about every one second, for example. From the GPS value acquired in the step S301, the sensor 101 acquires the speed over ground, travel direction (true bearing), latitude, and longitude as log data (step S302).

In parallel to acquisition of the GPS value in the step S301, the sensor 101 acquires values from the 9-axis sensor 202 (step S303). Specifically, the sensor 101 acquires measurements of accelerometers, gyroscopes, and geomagnetic sensors as log data. Specifically, the sensor 101 acquires the measurements about every 0.04 seconds.

The sensor 101 saves the log data acquired in the step S302 and the log data acquired in the step S303, in a predetermined storage region (a log data database 300) provided in the sensor 101 (step S304). This series of processes is continuously repeated during measurement.

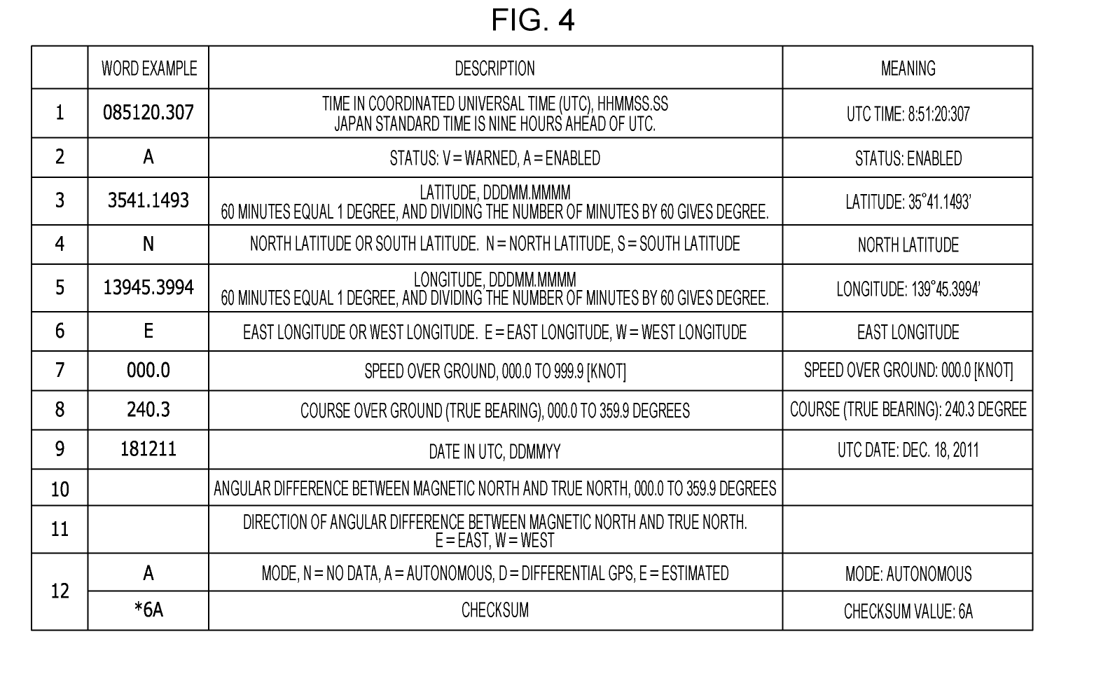

FIG. 4 is an explanatory view illustrating a format example of the GPS value. In the format illustrated in FIG. 4, item 7 indicates the speed over ground; item 8, the course over ground (true bearing); items 3 and 4, the latitude; and items 5 and 6, the longitude.

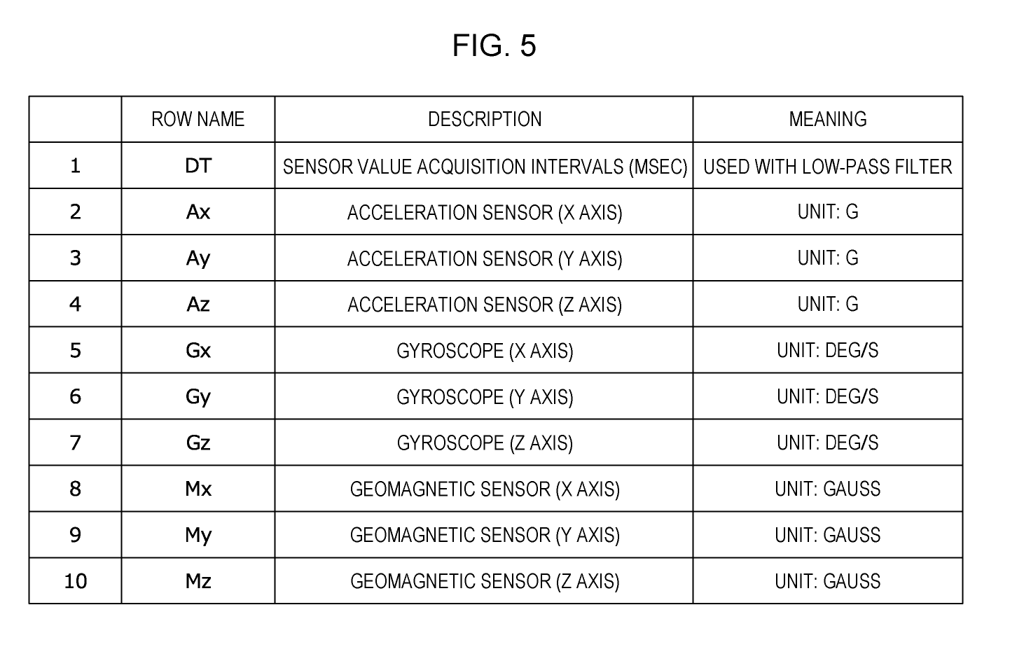

FIG. 5 is an explanatory view illustrating a format example of the 9-axis sensors. In FIG. 5, Ax, Ay, and Az indicate outputs of an accelerometer (X-axis), an accelerometer (Y-axis), and an accelerometer (Z-axis), respectively. Gx, Gy, and Gz indicate outputs of a gyroscope (X-axis), a gyroscope (Y-axis), and a gyroscope (Z-axis), respectively. Mx, My, and Mz indicate outputs of a geomagnetic sensor (X-axis), a geomagnetic sensor (Y-axis), and a geomagnetic sensor (Z-axis), respectively.

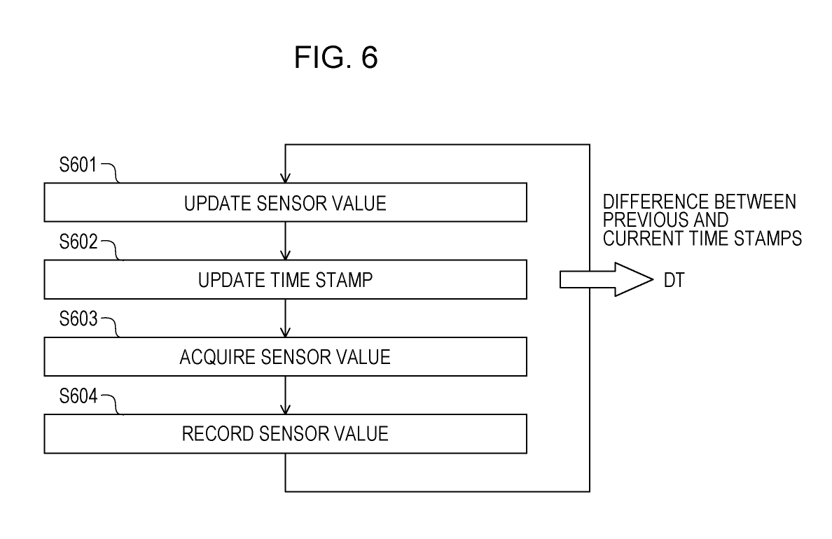

FIG. 6 is a flowchart illustrating a data acquisition procedure example of the 9-axis sensor. In the flowchart of FIG. 6, the 9-axis sensor 202 updates sensor values (step S601) and then updates the timestamp (step S602). The 9-axis sensor 202 acquires each sensor value (step S603) and records the acquired sensor value (step S604). The 9-axis sensor 202 then returns to the step S601 and repeatedly executes the steps S601 to S604.

By updating the timestamp in the step S602, the difference between current and previous values of the time stamp is acquired as a sensor value acquisition interval DT.

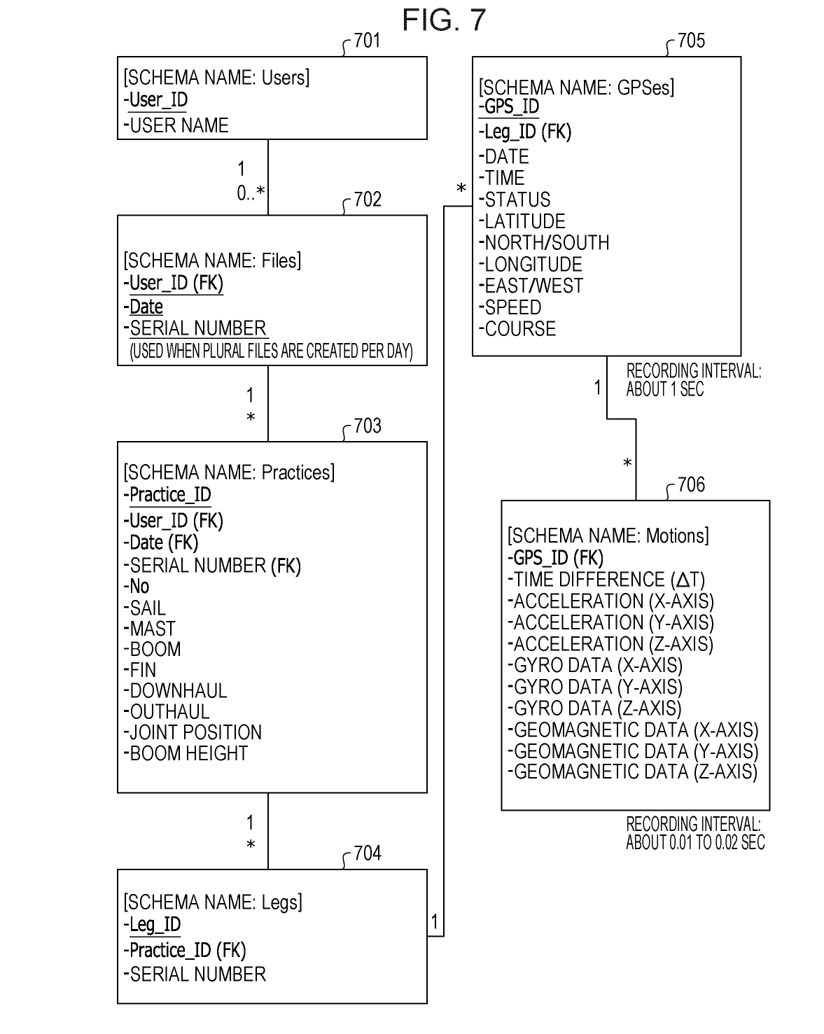

FIG. 7 is an explanatory view illustrating a format example of data acquired by the sensor. In FIG. 7, a schema 701 (schema name: Users) stores user ID and user name. A schema 702 (schema name; Files) stores the user ID as a foreign key (FK), date, and serial number (used when plural files are recorded in the day). The files are managed based on the date or the date and serial number.

A schema 703 (schema name: Practices) stores Practice ID and stores the user ID, date, and serial number as foreign keys (FK). The schema 703 stores No. (the number attached to the tool) and types of equipment of the sailboard 110, including the sail 113, the mast 111, the boom 114, the fin 117, a downhaul, an outhaul, a joint position, and boom height.

A schema 704 (schema name: Legs) stores Leg ID and further stores Practice ID as a foreign key (FK). In addition, the schema 704 stores the serial number of the leg.

A schema 705 (schema name: GPSes) stores GPS ID and Leg ID as a foreign key (FK). The schema 705 further stores the GPS value illustrated in FIG. 4, including date, time, status, latitude, north or south, longitude, east or west, speed, and course (bearing). The schema 705 is recorded about every one second.

A schema 706 (schema name: Motions) stores GPS ID as a foreign key (FK). The schema 706 stores values from the 9-axis sensor 202 (illustrated in FIG. 5), including time difference (AT), accelerations (X-axis, Y-axis, and Z-axis), gyroscope data (X-axis, Y-axis, and Z-axis), and geomagnetic data (X-axis, Y-axis, and Z-axis). The schema 706 is recorded about every 0.01 to 0.02 seconds.

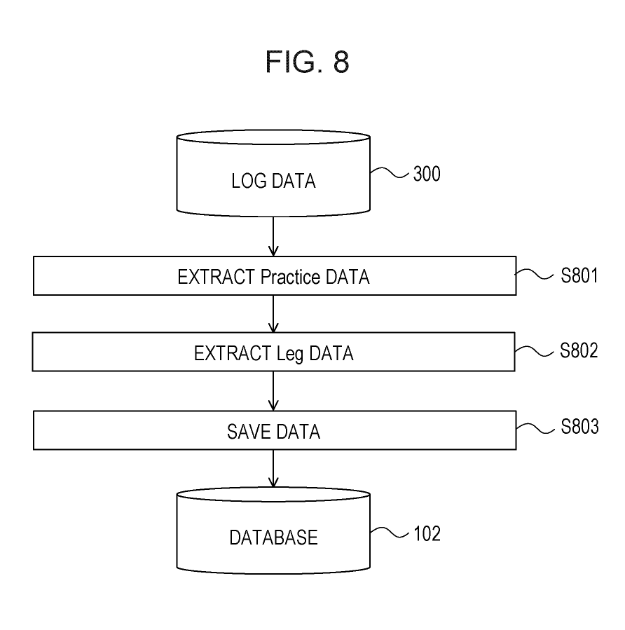

FIG. 8 is a flowchart illustrating a procedure example to register data in the database. In the flowchart of FIG. 8, first, data of a day (one record), data recorded from the time when a recording start button is pressed until the time when a recording stop button is pressed) are uploaded on a file basis from the log data 300 illustrated in FIG. 3.

Practice data is extracted from the file (step S801). Specifically, the data of a day (one record) is divided into sections, each corresponding to one outing from the launch of the sailboard 110 to return. Removing data during ground stand-by time from each section of data gives data of one Practice session (Practice data). In the GPS data, the ground stand-by time refers to a period of time when the movement speed (VOG) in the GPS data continues to be not higher than 0.5 km/h for 10 seconds or more.

Next, Leg data is extracted from the Practice data (step S802). Specifically, the Practice data is divided at each change in direction. When the movement direction (course over ground) in the GPS data changes greater than a certain degree, the range of five seconds after the change is considered as one leg.

The extracted Practice data and Leg data are stored (saved) in the database 102 (step S803), and the series of processes is terminated.

(Hardware Configuration Example of Information Processing Apparatus 103 and Steering Assist Apparatus 104)

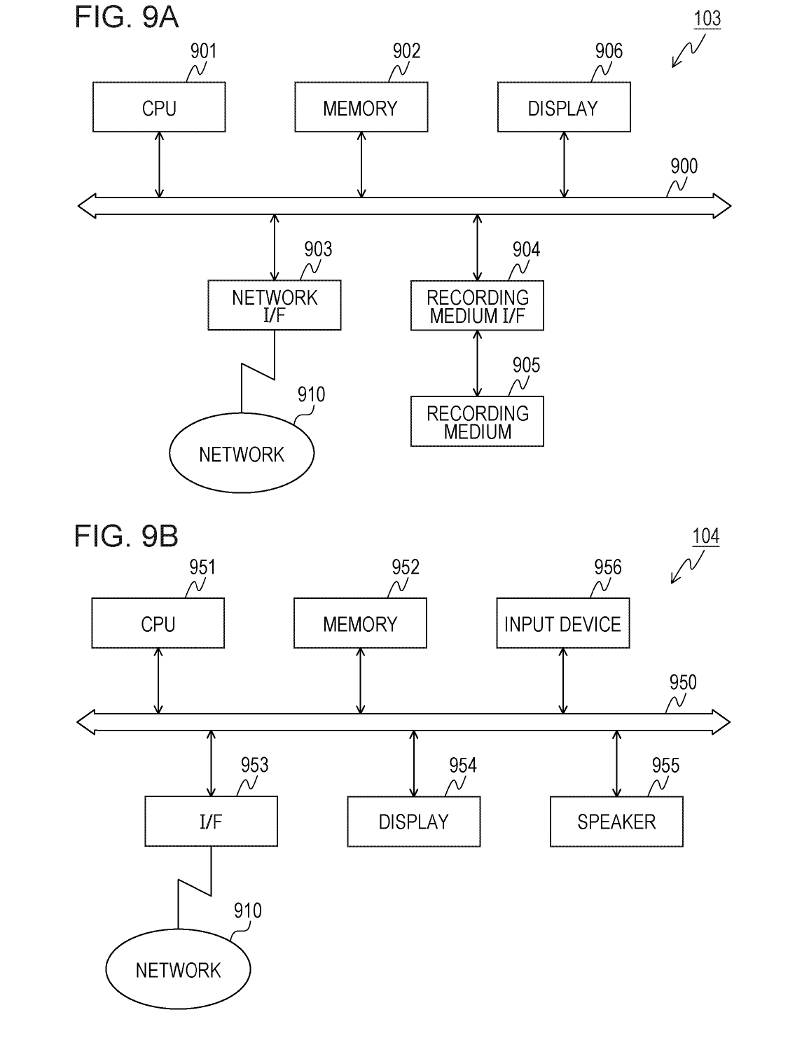

FIG. 9A is a block diagram illustrating a hardware configuration example of the information processing apparatus according to the embodiment. FIG. 9B is a block diagram illustrating a hardware configuration example of the steering assist apparatus according to the embodiment.

In FIG. 9A, the information processing apparatus 103 includes a CPU 901, a memory 902, a network interface (I/F) 903, a recording medium I/F 904, a recording medium 905, and a display 906. The components 901 to 904 and 906 are connected via a bus 900.

The CPU 901 manages overall control of the information processing apparatus 103. The memory 902 includes a read only memory (ROM), a random access memory (RAM), a flash ROM, and the like, for example. Specifically, the flash ROM and ROM store various programs, and the RAM is used as a work area of the CPU 901. The programs stored in the memory 902 are loaded by the CPU 901, and the CPU 901 executes coded processes.

The network I/F 903 is connected to the network 910 through a communication line and is connected to another apparatus (the steering assist apparatus 104, for example) or the like through the network 910. The network I/F 903 manages the interface between the network 910 and the components of the information processing apparatus 103 to control exchange of data with other devices. The network I/F 903 is a modem, a LAN adaptor, or the like.

The recording medium I/F 904 controls read and write of data for the recording medium 905 under control of the CPU 901. The recording medium 905 stores data written under control of the recording medium I/F 904. The recording medium 905 is a magnetic disk, an optical disk, or the like, for example.

The display 906 displays data of documents, images, videos, functional information, and the like, including a cursor, icons, and tool boxes. The display 906 is a liquid crystal display, an organic electroluminescence (organic EL) display, or the like, for example. The display 906 may be a head-mount display. This allows data replay through virtual reality.

In addition to the aforementioned components 901 to 906, the information processing apparatus 103 may include a solid state drive (SSD), a keyboard, and a pointing device (not illustrated), for example.

In FIG. 9B, the steering assist apparatus 104 includes a CPU 951, a memory 952, an I/F 953, a display 954, a speaker 955, and an input device 956. These components are connected through a bus 950.

The CPU 951 manages overall control of the steering assist apparatus 104. The memory 952 includes a ROM, a RAM, a flash ROM, and the like, for example. Specifically, the flash ROM and ROM store various programs, and the RAM is used as a work area of the CPU 951. The programs stored in the 952 are loaded by the CPU 951, and the CPU 951 executes coded processes.

The I/F 953 is connected to the network 910, such as the Internet, through a communication line and is connected to another apparatus (the information processing apparatus 103, for example) or the like through the network 910. The I/F 953 manages the interface between the network 910 and the components of the steering assist apparatus 104 to control exchange of data with other devices. The I/F 953 may be connected to other devices, including the information processing apparatus 103, through short-range wireless communication (Wi-Fi (registered trademark) or Bluetooth (registered trademark), for example).

The display 954 displays data of documents, images, videos, functional information, and the like, including a cursor, icons, and tool boxes. The display 954 is a liquid crystal display, an organic electroluminescence (EL) display, or the like, for example. The display 954 may be a head-mount display. This allows data replay through virtual reality.

The speaker 955 outputs voice, signal sounds, and the like. The speaker 955 may include a vibration function that transmits information through various types of vibrations. The speaker 955 may be an earphone-type speaker.

The input device 956 includes keys for inputting characters, numbers, various instructions for inputs of data. The input device 956 may be a keyboard, a pointing device, or the like or may be a touch-panel input pad, a numeric keypad, and the like.

In addition to the aforementioned components, the steering assist apparatus 104 may include various sensors, a hard disk drive (HDD), an SSD, a camera, or the like.

(Functional Configuration of Information Processing Apparatus 103 and Steering Assist Apparatus 104)

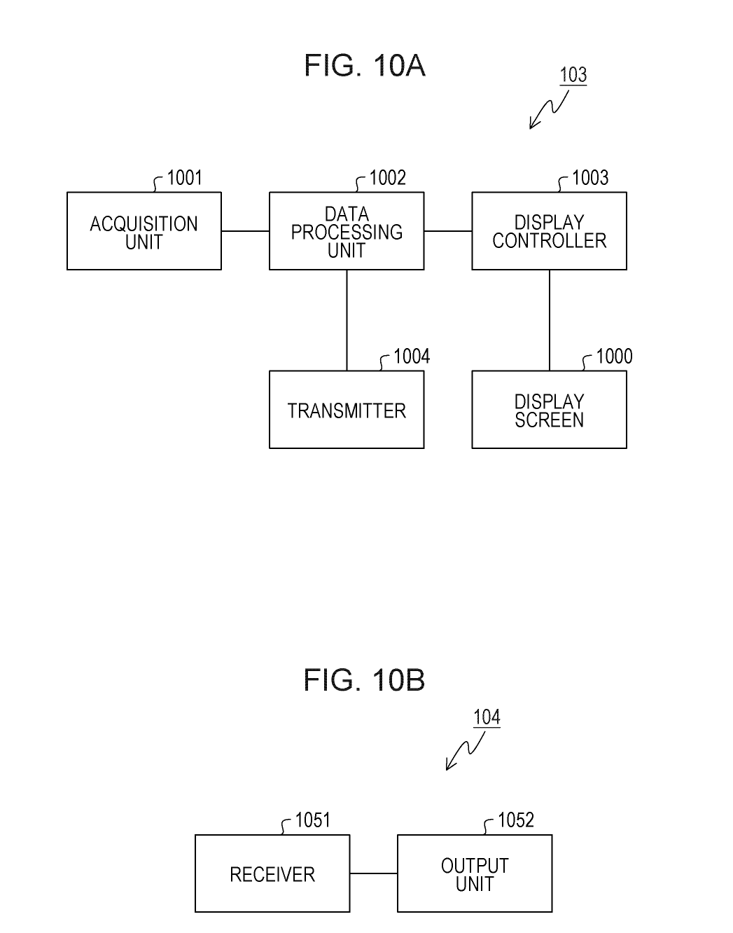

FIG. 10A is a block diagram illustrating a functional configuration example of the information processing apparatus according to the embodiment. In FIG. 10A, the information processing apparatus 103 includes a display screen 1000, an acquisition unit 1001, a data processing unit 1002, a display controller 1003, and a transmitter 1004. These acquisition unit 1001, data processing unit 1002, display controller 1003, and transmitter 1004 constitute a controller of the information processing apparatus 103.

Specifically, the function of the display screen 1000 is implemented through the display 906 illustrated in FIG. 9A, for example.

The acquisition unit 1001 acquires wind direction information indicating the measured wind direction around the sailboard 110. The acquisition unit 1001 receives inputs of position information concerning the varying position of the sailboard 110, specifically, the aforementioned GPS value. The acquisition unit 1001 acquires condition information concerning the condition of the moving body at each position, specifically, detection values from the 9-axis sensor 202.

The function of the acquisition unit 1001 is specifically implemented by the CPU 901 executing the programs stored in a storage, such as the memory 902 illustrated in FIG. 9A, or by the network I/F 903, for example.

The data processing unit 1002 calculates the movement direction and speed of the sailboard 110 based on the output from the position measurement sensor of the sailboard 110. With reference to the storage (the database 102, for example) that stores the wind direction measured during past movements of the sailboard 110 and the movement direction and speed of the sailboard 110, the data processing unit 1002 specifies a recommended movement direction or a recommended sail position of the sailboard 110.

The data processing unit 1002 calculates the speed of the sailboard 110 at each location based on the position information. The data processing unit 1002 calculates the travel direction (abeam, close-hauled, or quarter-lee, for example) of the sailboard 110 in relation to the wind direction at each location, based on the position information.

Specifically, the function of the data processing unit 1002 is implemented by the CPU 901 executing a program stored in the storage, such as the memory 902 illustrated in FIG. 9A, for example.

The display controller 1003 displays change in speed with time in a graph. The display controller 1003 may display variations in both speed and travel direction with time through a graph. The display controller 1003 may display at least one of the maximum speed and average speed through a graph. The graph may plot the time elapsed from the launch and speed at each time, as two parameters.

The display controller 1003 may display a first mark indicating a position on the graph while displaying a second mark at the position on the track of the sailboard 110 on the map, which is synchronized in time with the position on the graph indicated by the first mark.

The display controller 1003 may display condition information which is synchronized in position and time with the graph where the first mark is displayed. The condition information may be information concerning the inclination of the mast 111 of the sailboard 110. The condition information may be information concerning the rotation angle of the sail 113 of the sailboard 110.

The display controller 1003 may allow the first mark to automatically move along the time axis in the graph.

Specifically, the function of the display controller 1003 is implemented by the CPU 901 executing a program stored in the storage, such as the memory 902 illustrated in FIG. 9A, for example.

The transmitter 1004 transmits the recommended movement direction or recommended sail position specified by the data processing unit 1002, to the steering assist apparatus 104. Specifically, the function of the transmitter 1004 is implemented through the network I/F 903 illustrated in FIG. 9A or the like, for example.

FIG. 1013 is a block diagram illustrating a functional configuration example of a steering assist apparatus according to the embodiment. In FIG. 10B, the steering assist apparatus 104 includes a receiver 1051 and an output unit 1052. These receiver 1051 and output unit 1052 constitute a controller of the steering assist apparatus 104.

The receiver 1051 receives the recommended movement direction or recommended sail position of the sailboard 110 from the information processing apparatus 103. Specifically, the function of the receiver 1051 is implemented through the I/F 953 or the like, for example.

The information processing apparatus 103 may be configured to receive the location measured by the position measurement sensor mounted on the sailboard 110 or the movement direction and speed of the sailboard 110 calculated based on the location and calculate the recommended movement direction or recommended sail position of the sailboard 110 with reference to the storage that stores the history of movement of the sailboard 110 and the wind direction information around the sailboard 110.

The output unit 1052 outputs the recommended movement direction or recommended sail position received by the receiver 1051 by displays or sounds. Specifically, the function of the output unit 1052 is implemented through the display 954 or speaker 955 illustrated in FIG. 9B or another device.

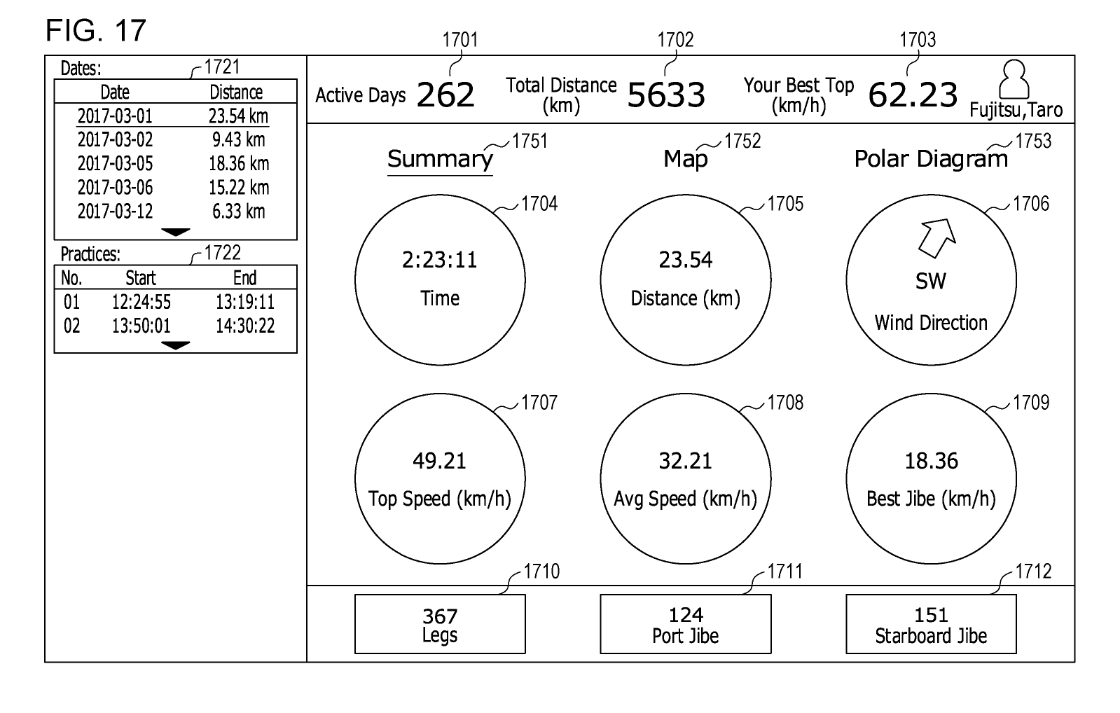

The output unit 1052 displays display screens illustrated in FIGS. 17 to 22 (described later), for example. The output unit 1052 transmits information to be given to the user through various types of alarms and buzzers in addition to voice.

(Detail of Processes)

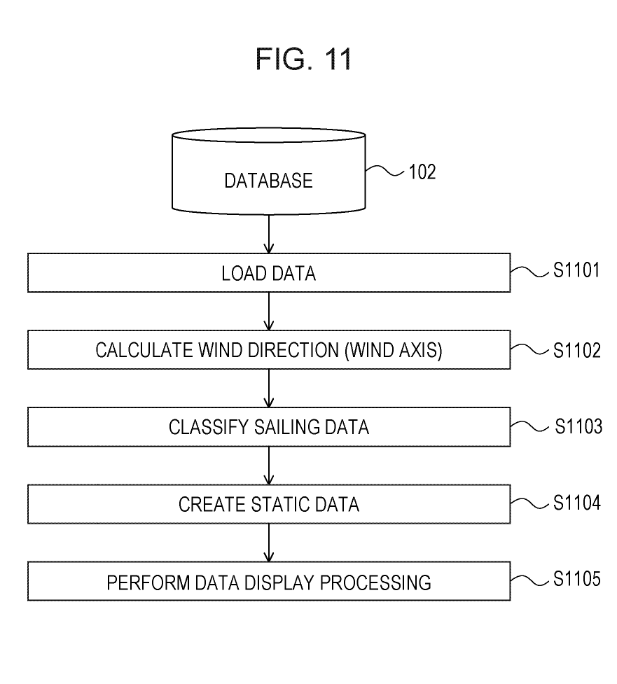

FIG. 11 is a flowchart illustrating a data display procedure example. In the flowchart of FIG. 11, the information processing apparatus 103 loads data from the database 102 (step S1101). Next, based on the loaded data, the information processing apparatus 103 calculates the wind direction (wind axis) (step S1102).

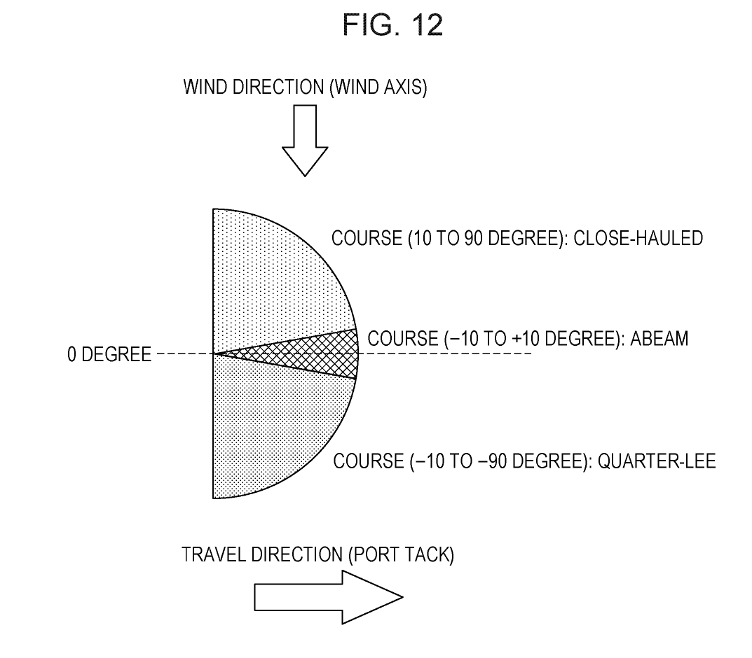

Next, the information processing apparatus 103 classifies sailing data (step S1103). The information processing apparatus 103 classifies the sailing data into three groups in relation to the “course over ground” of the GPS data based on criteria illustrated in FIG. 12. Herein, the orthogonal line to the wind is set to 0 degrees.

Next, the information processing apparatus 103 creates static data (step S1104). The information processing apparatus 103 performs data statistical processing to display a polar curve and loads all the GPS data of the same user for overall calculation. The information processing apparatus 103 calculates [maximum speed and direction] and [various VMG]. VMG (velocity made good) is an effective speed that means velocity in the intended direction (how far the board sails in the intended direction). In addition, the information processing apparatus 103 performs a jibe understanding process. Jibe is a downwind turn in which the back of the board passes through the wind.

The information processing apparatus 103 then performs data display processing (step S1105). The series of processes is terminated.

FIG. 12 is an explanatory view illustrating classification of the sailing data. In FIG. 12, sailing in the direction from −10 to +10 degrees is “abeam”, that is, sailing at right angles to the wind; sailing in the direction from 10 to 90 degrees is “close-hauled”, that is, sailing upwind; and sailing in the direction from −10 to −90 degrees is “quarter-lee”, that is sailing downwind.

In addition, sailing data is classified into two: “port tack” for sailing to the right in relation to the wind (wind axis) and “starboard tack” for sailing to the left. FIG. 12 illustrates “port tack”. In the case of “starboard tack”, the diagram is reversed right and left, and the sailing data is classified into three on the reversed diagram.

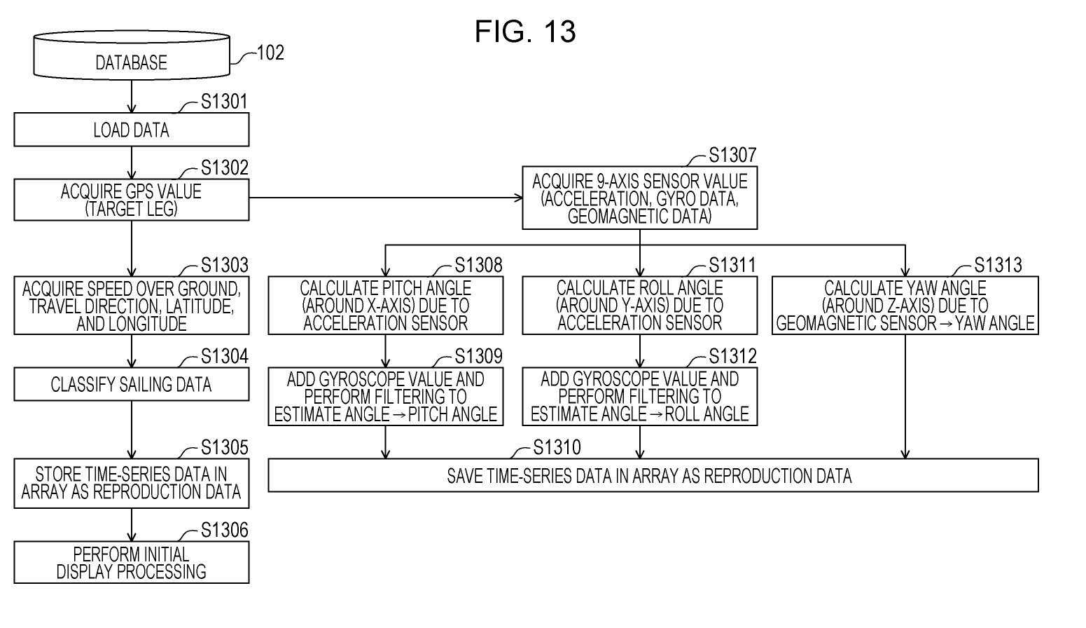

FIG. 13 is a flowchart illustrating a procedure example to calculate angle data. In the flowchart of FIG. 13, the information processing apparatus 103 first loads data from the database 102 (step S1301). Next, the information processing apparatus 103 acquires GPS value of a target leg from the loaded data (step S1302). Based on the acquired GPS value, the information processing apparatus 103 then acquires the speed over ground, course over ground, latitude, and longitude (step S1303).

Next, the sailing data is classified (step S1304). Specifically, based on the classification of the sailing data in the step S1103 of the flowchart of FIG. 11, the sailing data is colored-coded depending on the travel direction.

The information processing apparatus 103 stores time-series data in an array as replay data (step S1305) and then performs initial display processing (step S1306). Specifically, the information processing apparatus 103 performs a process to plot GPS point cloud data on a map and connect consecutive points with lines.

The information processing apparatus 103 also acquires values of the 9-axis sensor 202 in accordance with the GPS value of the target leg acquired in the step S1302 (step S1307). The information processing apparatus 103 calculates a pitch angle (an angle about the X-axis) by the accelerometer, in the values of the 9-axis sensor 202 (step S1308).

Additionally using a gyroscope value among the acquired values of the 9-axis sensor 202, the information processing apparatus 103 performs filtering for the calculated pitch angle to estimate an angle (step S1309). The estimated angle is a final pitch angle. The filtering is performed using a complementary filter, a linear Kalman filter, an unscented Kalman filter, or the like, for example.

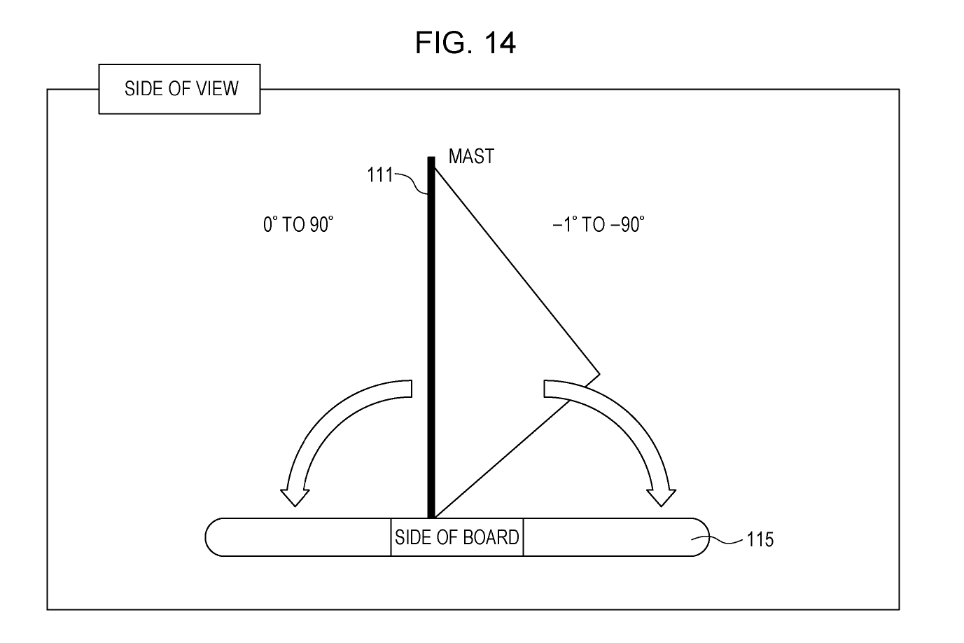

FIG. 14 is an explanatory view illustrating calculation of the pitch angle. FIG. 14 illustrates a side view of the sailboard 110. In FIG. 14, the pitch angle (Euler angle) is 0 degree when the mast 111 is at a right angle to the board 115. The pitch angle has a positive value (0 to 90 degrees) when the mast 111 leans forward, that is, inclines to the nose. The pitch angle has a negative value (−1 to −90 degrees) when the mast 111 leans backward, that is, inclines to the tail. This range is a range of calculable pitch angle.

The pitch angle is calculated by Formula 1.

Pitch angle=ATAN((ax)/SQRT(ay*ay+az*az)) Formula 1

where ax is an X-axis accelerometer value; ay is a Y-axis accelerometer value; and az is a Z-axis accelerometer value.

The information processing apparatus 103 calculates a roll angle from the accelerometer (an angle about the Y-axis), among the values of the 9-axis sensor 202 acquired in the step S1307 (step S1311). By additionally using a gyroscope measurement among the acquired values of the 9-axis sensor 202, the information processing apparatus 103 performs filtering to estimate an angle (step S1312). This estimated angle is a final roll angle.

The filtering is performed using a complementary filter, a linear Kalman filter, an unscented Kalman filter, or the like, for example, in the same way as the filtering used to estimate the pitch angle.

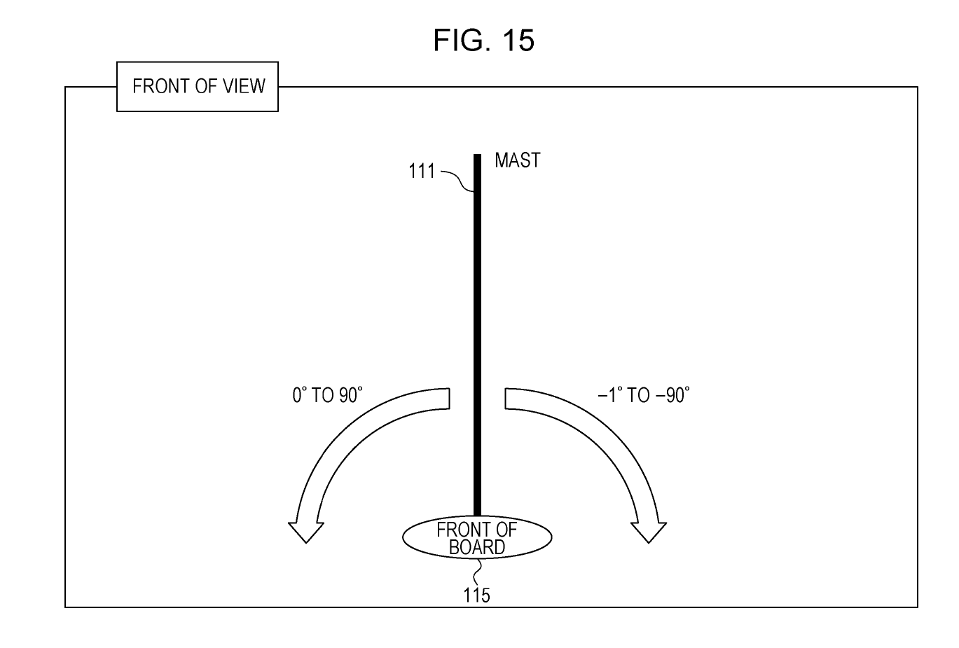

FIG. 15 is an explanatory view illustrating calculation of the roll angle. FIG. 15 illustrates a front view of the sailboard 110 (seen from the nose side). In FIG. 15, the roll angle (Euler angle) is 0 degree when the mast 111 is at a right angle to the board 115. The roll angle has a positive value (0 to 90 degrees) when the mast 111 leans toward the left side in the drawing, that is, inclines to the port side of the board 115. The roll angle has a negative value (−1 to −90 degrees) when the mast 111 leans toward the right side in the drawing, that is, inclines to the starboard side of the board 115. This range is a range of calculable roll angles.

The roll angle is calculated by Formula 2.

Roll angle=ATAN((ay)/SQRT(ax*ax+az*az)) Formula 2

The information processing apparatus 103 calculates the yaw angle, which is an angle around the Z-axis, from the geomagnetic sensor among the values of the 9-axis sensor 202 acquired in the step S1307 (step 1313).

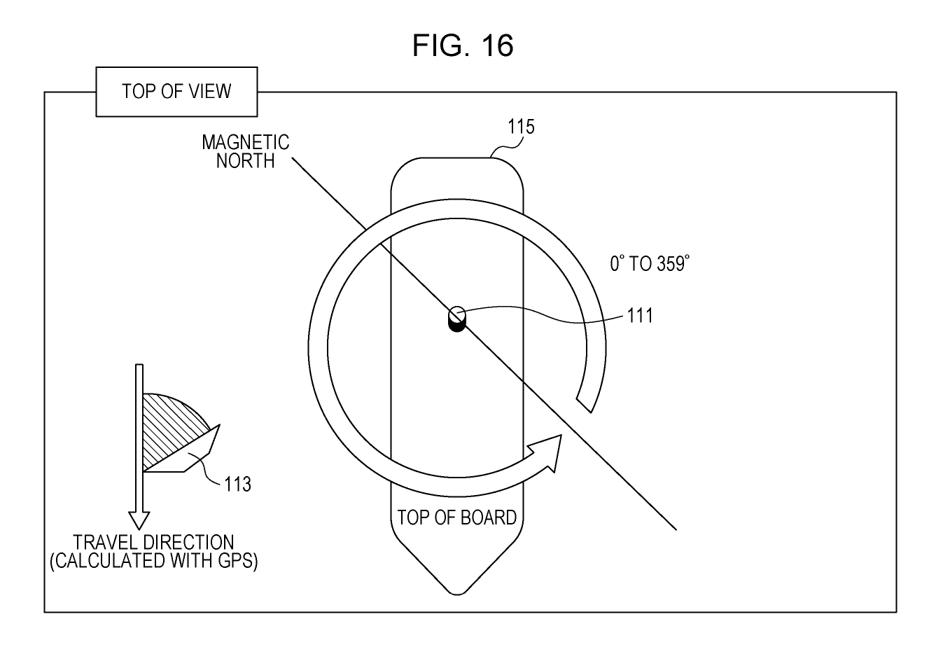

FIG. 16 is an explanatory view illustrating calculation of the yaw angle. FIG. 16 illustrates the top view of the sailboard 110. In FIG. 16, the yaw angle is an angle of rotation of the sail 113 around the mast 111 relative to the magnetic north. The yaw angle is 0 degrees when the sail 113 is positioned with the mast 111 side on the magnetic north side, that is, the boom end is located on the opposite side to the magnetic north. The counterclockwise range from 0 to 359 degrees is a range of calculable yaw angles.

The angle of rotation of the sail 113 is calculated through gyro correction using a law-pass filter based on the values of the geomagnetic sensor since the travel direction is calculated from the GPS value.

The Yaw angle is calculated by the following formulae 3 to 5.

magX: X-axis geomagnetic sensor value

magY: Y-axis geomagnetic sensor value

Yaw=atan2 (magX, magY);

if (Yaw<0) Yaw+=2*PI;

if (Yaw>2*PI) Yaw−=2*PI; Formula 3

Yaw=Yaw*180/M_PI;

//corrected for easterly variation (Japan) Formula 4

Yaw=Yaw+6.6; //magnetic deviation 6.6 degrees

if (Yaw>360.0) Yaw=Yaw−360.0; Formula 5

The information processing apparatus 103 then stores time-series data of the pitch angle estimated in the step S1309, the roll angle estimated in the step S1312, and the yaw angle calculated in the step S1313, in an array as the replay data (step S1310), terminating the series of processes.

(Contents of Data Display)

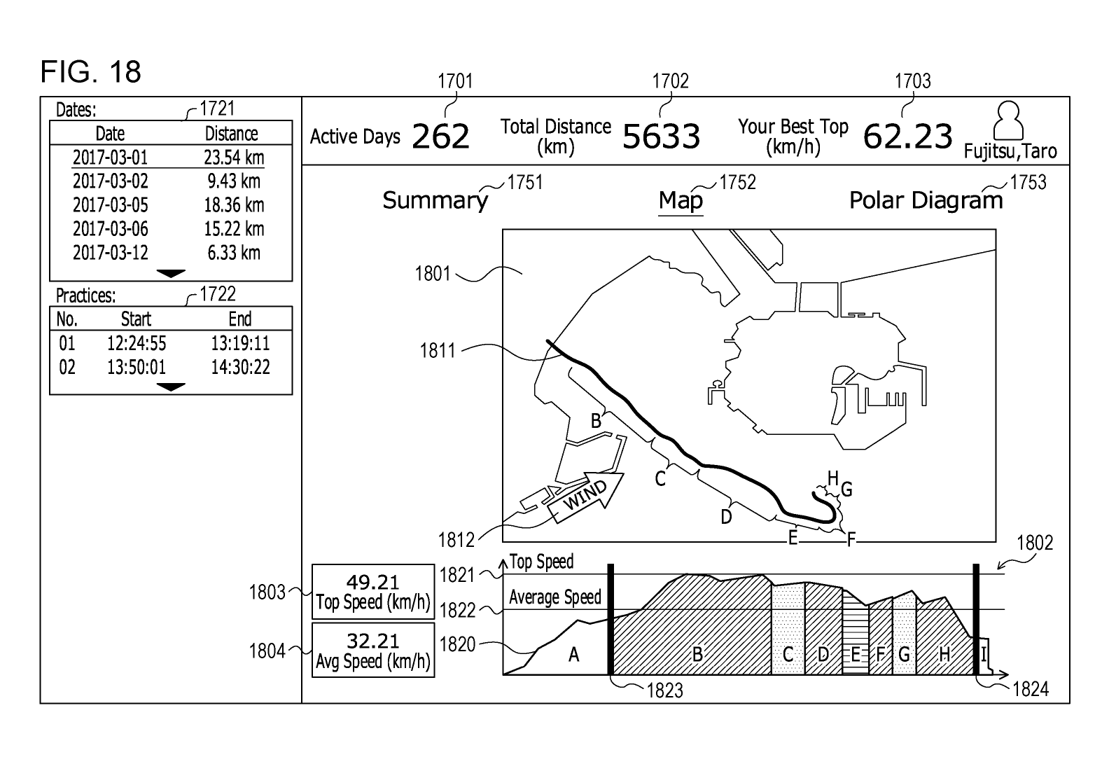

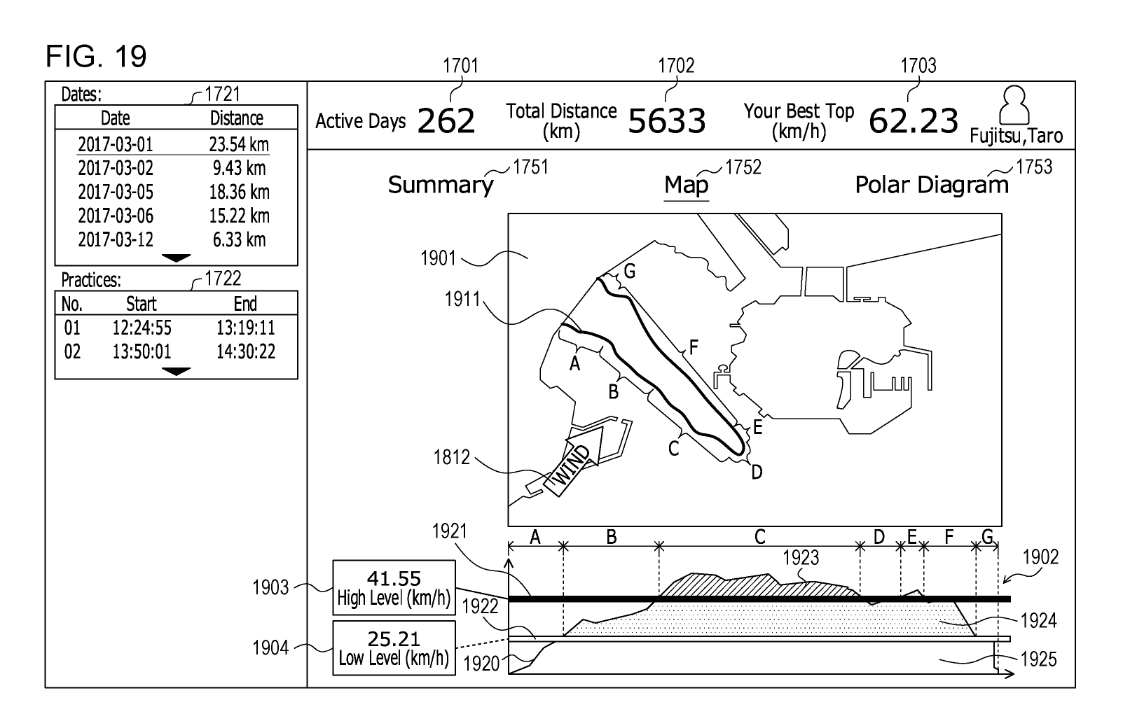

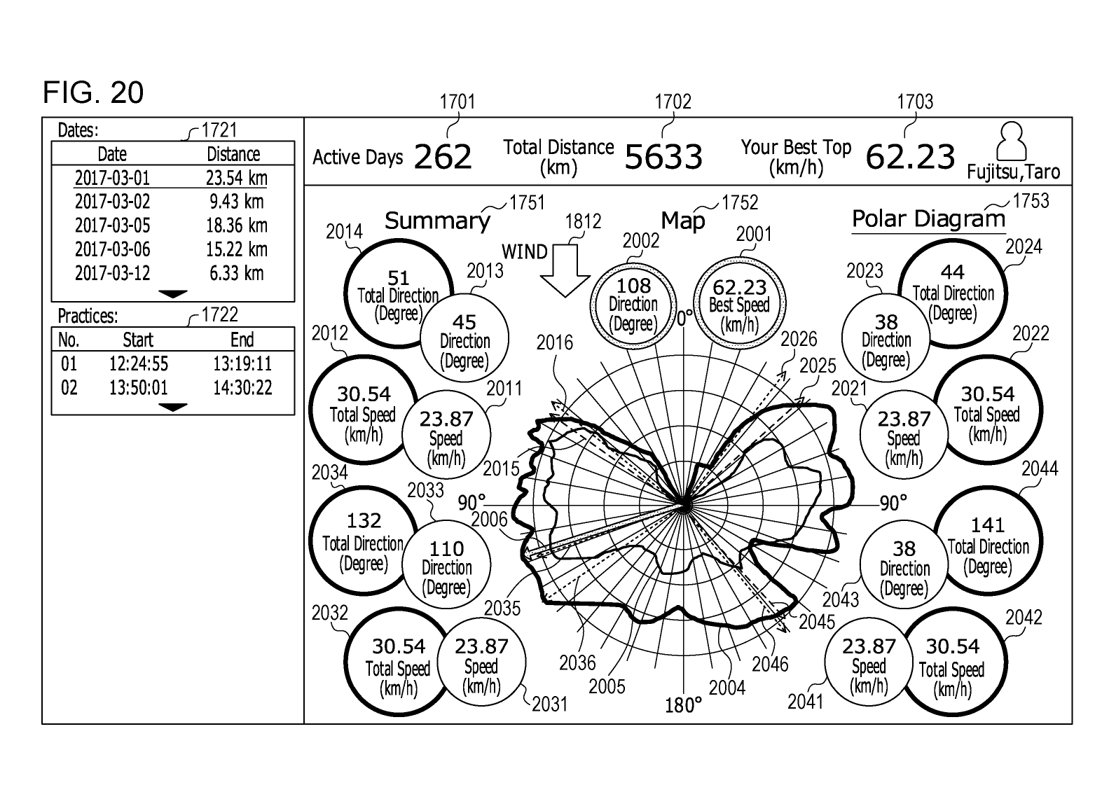

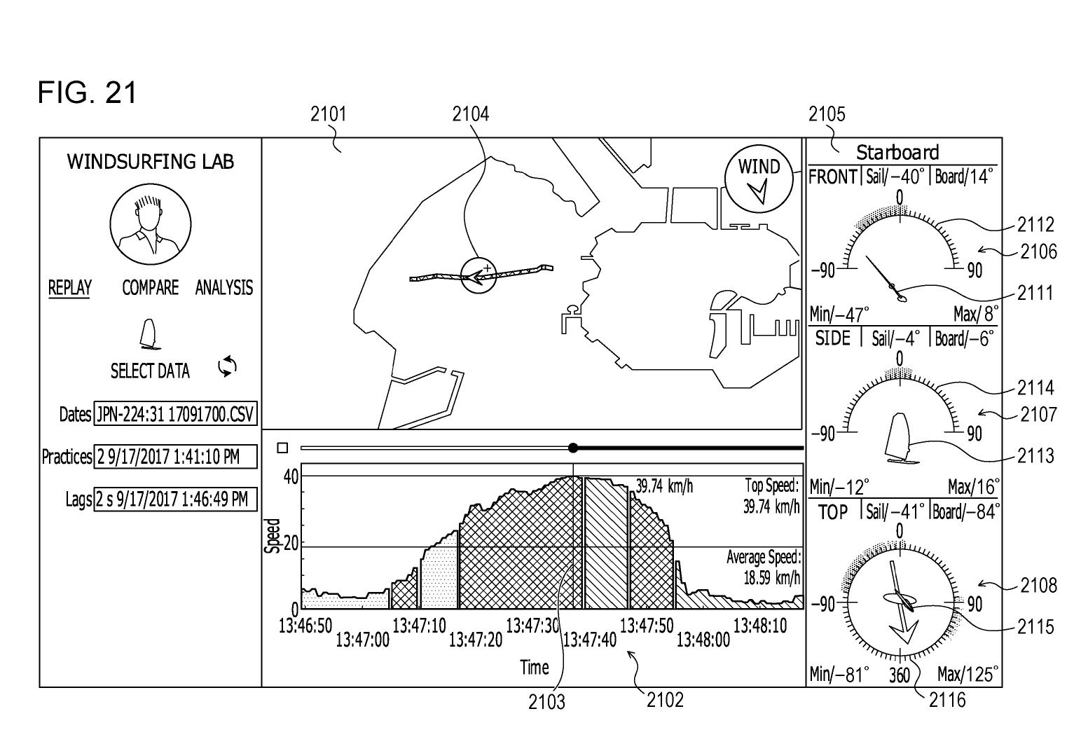

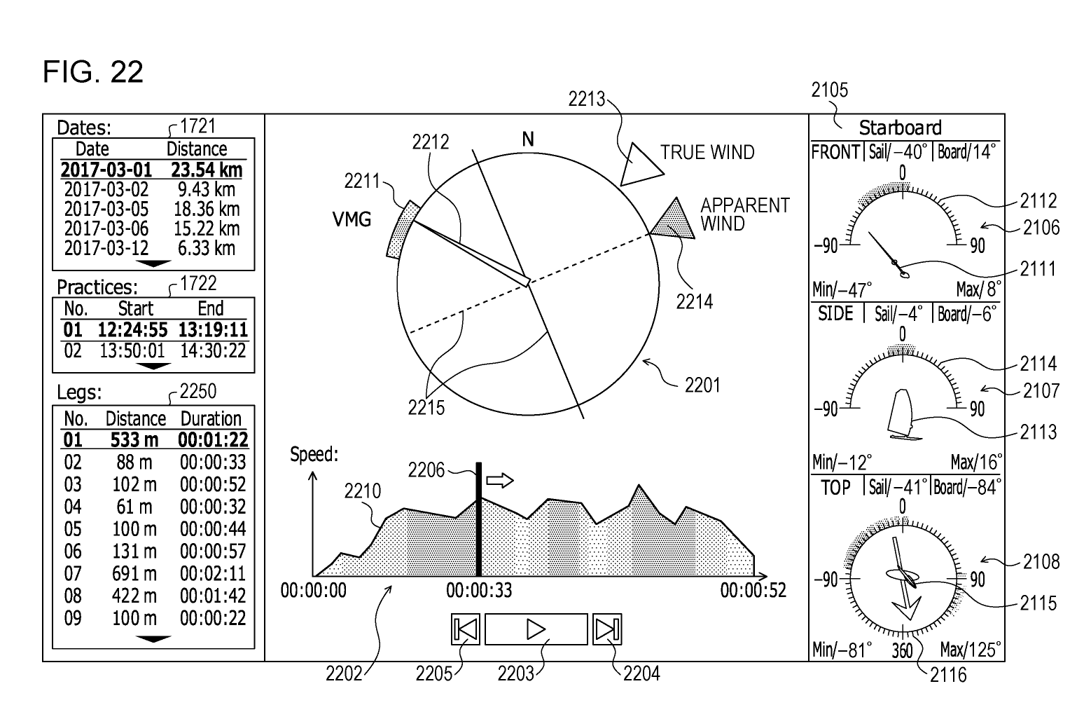

FIGS. 17 to 22 are explanatory views illustrating contents of data displays. FIG. 17 is a summary display example; FIGS. 18 and 19 are map display examples; and FIG. 20 is a polar diagram display example. FIGS. 21 and 22 are application examples of the map display. The displays illustrated in FIGS. 17 to 22 may be displayed by the steering assist apparatus 104 or may be displayed on the display screen 1000 of the information processing apparatus 103.

(Summary Display)

FIG. 17 illustrates the summary display. In FIG. 17, in the upper field of the display screen, “Active Days” 1701, “Total Distance” 1702, “Your Best Top” 1703 are displayed.

The “Active Days” 1701 indicates the total number of days the user sailed or practiced sailing. Herein, the total number of days is 262 days. The “Total Distance” 1702 indicates the total distance the user sailed (sailed the sailboard 110). The total distance herein is 5633 km. The “Your Best Top” 1703 indicates the maximum speed in the total number of days (total distance) the user sailed. The maximum speed herein is 62.23 km/h (62.23 kilometers per hour).

In FIG. 17, “Time” 1704, “Distance” 1705, and “Wind Direction” 1706 are displayed, from left to right on the upper row in the main field of the display screen.

The “Time” 1704 indicates how many hours the user sailed in the day, that is, the time duration from when a sensor recording start button is pressed until a recording end button is pressed. The time duration herein is 2:23:11 (2 hours 23 minutes 11 seconds).

The “Distance” 1705 indicates the total distance that the user sailed in the day, that is, the distance traveled from when the sensor recording start button is pressed until the recording end button is pressed. The distance herein is 23.54 (km). The total distance may be a value calculated based on GPS values.

The “Wind direction” 1706 indicates the wind direction predicted from the sailing data. The “Wind direction” 1706 includes “SW” (southwest wind) and an arrow pointing upper right to represent southwest wind. The wind direction is calculated in the step S1102 of the flowchart of FIG. 11.

As described above, the upper row displays objective information concerning the history of sailing, not relating to the sailing technique directly.

In FIG. 17, “Top Speed” 1707, “Avg Speed” 1708, and “Best Jibe” 1709 are displayed from left to right on the lower row in the main field of the display screen. The “Top Speed” 1707 indicates the maximum speed recorded in the data of the day. Herein, the maximum speed of the day is 49.21 (km/h) (49.21 kilometers per hour). The “Avg Speed” 1708 indicates average speed in the data of the day (other than the ground stand-by time). The average speed is 32.21 (km/h) (32.21 kilometers per hour) herein.

The “Best Jibe” 1709 indicates the maximum exit speed at the jibes recorded in the data of the day. The maximum exit speed is 18.36 (km/h) (18.36 kilometers per hour) herein.

In FIG. 17, “Legs” 1710, “Port Jibe” 1711, and “Starboard Jibe” 1712 are displayed in the field under the main field in the display screen.

The “Legs” 1710 indicates the number of legs recorded in the data of the day. The number of legs is 367 herein. The “Port Jibe” 1711 indicates the number of jibes from port tack (sailing across wind hitting the port side of the board 115, where the rider's left hand and foot are on the front side.). The number of jibes is 124 herein. The “Starboard Jibe” 1712 indicates the number of jibes from starboard tack (sailing across wind hitting the starboard side of the board 115 (opposite to port tack sailing), where the rider's right hand and foot are on the front side.). The number of jibes is 151 herein.

In the main field of the display screen, six items are displayed in circles. The values of the items are analogue, and such circular expression allows the user to intuitively understand the images of analogue values. In the bottom field of the display screen, three items are displayed in rectangles. The values of these items are digital, and such rectangle expression allows the user to intuitively recognize the images of digital values. Varying the design of the items to be displayed allows the user to recognize data more intuitively.

The values displayed in the left field of the display screen are a daily data list 1721 including summary of each day. The daily data list 1721 includes dates (Date) and total distances (Distance) that the user sailed in the corresponding dates, in chronological order. The list 1721 is designed to be sorted in ascending and descending order of dates (Date) or total distances (Distance). By selecting the summary (date) desired to be displayed in the list 1721, the corresponding daily data is displayed.

In FIG. 17, the data is displayed in descending order of dates (Date). “2017-03-01 23.54 km” at the top is selected and highlighted. Herein, “2017-03-01 23.54 km” corresponds to “2:23:11” of the “Time” 1704 and distance “23.54 km” of the “Distance” 1705.

Under the daily data list 1721 including summary, a list 1722 including summary of plural Practice sessions in the daily data which is selected in the list 1721, is displayed. The list 1722 includes the serial number of each Practice session (No.), the start time of the Practice session (Start), and the end time of the Practice session (End). By selecting the summary (Practice) desired to be displayed, data of the corresponding Practice session is displayed.

In FIG. 17, no summary (Practice) is selected, and the summaries in the list 1722 are displayed in the same manner. When any summary (Practice) is selected, the selected summary is highlighted, and the summary data including the items 1704 to 1712 are displayed in the main and bottom fields.

In FIG. 17, screen change buttons are provided in upper part of the main field of the display screen, including a “Summary” button 1751, a “Map” button 1752, and a “Polar Diagram” button 1753. Selecting the “Summary” button 1751 provides the screen of summary illustrated in FIG. 17. Selecting the “Map” button 1752 provides a display screen including a map illustrated in FIGS. 18 and 19. Selecting the “Polar Diagram” button 1753 provides a display screen including a polar diagram (FIG. 20).

In FIG. 17, the summary screen is displayed, and the display style (including colors) of the “Summary” button 1751 is different from that of the “Map” button 1752 and “Polar Diagram” button 1753. When the position where the “Map” button 1752 or “Polar Diagram” button 1753 is displayed is clicked with a pointing device or touched with a finger, the summary screen is easily changed to the display screen illustrated in FIG. 18 or 19, or to the display screen illustrated in FIG. 20.

(Map Display)

FIG. 18 illustrates the contents of the map. FIG. 18 illustrates a map section 1801 in the center and a speed display section 1802 under the map section 1801. The speed display section 1802 includes a line graph 1820 representing change in speed with time.

The contents of the “Active Days” 1701, “Total Distance” 1702, and “Your Best Top” 1703 in the upper field of the display screen are the same as those in FIG. 17. The daily data list 1721 including summary and the list 1722 including summary of the plural Practice sessions in the daily data in the left field of the display screen are the same as those illustrated in FIG. 17.

The screen change buttons displayed in upper part of the main field of the display screen, including the “Summary” button 1751, “Map” button 1752, and “Polar Diagram” button 1753, are the same as those illustrated in FIG. 17. In FIG. 18, since the map is displayed, the display style (including colors) of the “Map” button 1752 is different from that of the “Summary” button 1751 and “Polar Diagram” button 1753.

In FIG. 18, the map section 1801 includes a track 1811 of movement (sailing) of the sailboard 110 and an arrow 1812 indicating the wind direction.

In FIG. 18, the speed display section 1802 displays a line graph 1820 representing speed with time in the horizontal axis (X-axis) and speed in the vertical axis (Y-axis). The vertical axis (Y-axis) represents two lines of a line (Top Speed) 1821 and a line (Average Speed) 1822, which are parallel to the horizontal axis (X-axis). The line (Top Speed) 1821 represents the maximum speed while the line (Average Speed) 1822 represents the average speed. The maximum speed and average speed are displayed in “Top Speed” 1803 and “Average Speed” 1804, respectively.

The horizontal axis (X-axis) represents two lines of a line 1823 indicating the start time on the map and a line 1824 indicating the end time. The lines 1823 and 1824 are parallel to the vertical axis (Y-axis). The track displayed in the map section 1801 corresponds to only the range of time between the two lines 1823 and 1824.

The line graph 1820 is divided into nine regions A to I. The region A is before the line 1823 and is not displayed on the map. The region A is not color-coded or is represented in a color (gray, for example) to be differentiated from the other color-coded regions.

The regions B, D, F, and H represent abeam. The abeam regions are colored in red, for example. The regions C and G represent quarter-lee. The quarter-lee regions are desirably colored in blue, for example. The region E represents close-hauled. The close-hauled region is colored in yellow, for example.

The region I is after the line 1824 and is not displayed as the track 1811 in the map section 1801. The region I is not color-coded or is colored in gray, for example, in a similar manner to the region A.

The regions B to H of the line graph 1820 in the speed display section 1802 are color-coded based on the sailing type like: “abeam (red)” in the region B, “quarter-lee (blue)” in the region C, “abeam (red)” in the region D, “close-hauled (yellow)” in the region E, “abeam (red)” in the region F, “quarter-lee (blue)” in the region G, and “abeam (red)” in the region H.

The track 1811 of movement (sailing) of the sailboard 110 is displayed in the same colors as those used in the speed display section 1802. As illustrated in FIG. 18, the sections B to H in the track 1811 are colored in the same colors as those of the regions B to H in the line graph 1820 in the speed display section 1802, respectively (the section B is red; the section C is blue; the section D is red; the section E is yellow; the section F is red; the section G is blue; and the section H is red). The sailing types are thereby color-coded.

Such a configuration improves visual understanding of data. Specifically, synchronization of the track 1811 in the map section 1801 and the line graph 1820 in the speed display section 1802 enables easy and institutive understanding of speed at each location on the track 1811, allowing instantaneous determination about how the rider was sailing. Accordingly, the user clearly understands how the sailboard 110 was traveling and determine how the sailboard 110 was sailing (close-hauled, abeam, quarter-lee, or the like).

FIG. 19 illustrates a map section 1901 and a speed display section 1902 similarly to FIG. 18. Similarly to FIG. 18, the speed display section 1902 displays a line graph 1920 that represents change in speed, with time in the horizontal axis (X-axis) and speed in the vertical axis (Y-axis). The vertical axis (Y-axis) represents two lines of a line (High level) 1921 and a line (Low level) 1922, which are parallel to the horizontal axis (X-axis).

The line (High level) 1921 represents an upper limit speed while the line (Low level) 1922 represents a lower limit speed. The upper limit speed (41.55 (km/h)) and lower limit speed (25.21 (km/h)) are displayed in “High Level” 1903 and “Low Level” 1904, respectively.

The line graph 1920 is divided into three regions (regions 1923, 1924, and 1925) by the line (High level) 1921 and line (Low Level) 1922. The region 1923 of speed faster than the upper limit speed, is represented in red. The region 1924 of speed slower than the upper limit speed and not slower than the lower limit speed, is represented in blue. The region 1925 of speed slower than the lower limit speed, is represented in gray.

In FIG. 19, sections A to G are set based on the intersections of the line graph 1920 and the lines 1921 and 1922. Specifically, the sections A and G are in the region 1925, the sections B, D, and F are in the region 1924, and the sections C and E are in the region 1923.

The sections A to G in a track 1911 in the map section 1901 are color coded in synchronization with the colors in the speed display section 1902. Specifically, the sections A to G are colored in such a manner: “gray in section A”, “blue in section B”, “red in section Cu”, “blue in section D”, “red in section E”, “blue in section F”, and “gray in section G”.

In the aforementioned configuration, synchronization of the track 1911 in the map section 1901 and the line graph 1920 in the speed display section 1902 enables easy and institutive understanding of speed at each location on the track 1911 similarly to FIG. 18.

(Polar Diagram Display)

FIG. 20 is an explanatory view illustrating a polar diagram. In FIG. 20, in relation to the wind direction (WIND) indicated by the arrow 1812, the polar diagram is displayed at the center while “Best Speed” 2001 and “Direction” 2002 are displayed above the center of the diagram. The “Best Speed” 2001 indicates a record top speed of the user, which is 62.23 (km/h) herein. The “Direction” 2002 indicates the angle at the record top speed, which is 108 degrees herein.

Around the polar diagram, four circular expressions indicating numerical values are displayed in each of the regions located to the upper left, upper right, lower left, and lower right of the polar diagram.

To the upper left in the drawing, “Speed” 2011, “Total Speed” 2012, “Direction” 2013, and “Total Direction” 2014 concerning upward speed and angle of upwind VMG on starboard tack in the selected day are displayed.

The “Speed” 2011 indicates upward speed of upwind VMG on starboard tack in the selected day, which is 23.87 (km/h). The “Total Speed” 2012 indicates upward speed of overall upwind VMG on starboard tack, which is 30.54 (km/h).

The “Direction” 2013 indicates an upward angle of upwind VMG on starboard tack in the selected day, which is 45 degrees. The “Total Direction” 2014 indicates an upward angle of overall upwind VMG on starboard tack, which is 51 degrees.

As illustrated in FIG. 20, the circles indicating the values concerning the overall upwind VMG are larger than those indicating the values concerning the upwind VMG in the selected day and are located outside of the same. This gives an image that the upward speed and angle of upwind VMG in the selected day are included in those of overall upwind VMG, thus allowing the user to institutively identify which value is of upwind VMG of the selected day and which value is of overall upwind VMG. Moreover, the outlines of the circles indicating the values of the selected day may be colored in different colors from those of the overall upwind VMG in order to further clarify which value is of the selected day.

To the upper right in the drawing, “Speed” 2021, “Total Speed” 2022, “Direction” 2023, and “Total Direction” 2024 concerning upward speed and angle of upwind VMG on port tack in the selected day are displayed.

To the lower left in the drawing, “Speed” 2031, “Total Speed” 2032, “Direction” 2033, and “Total Direction” 2034 concerning upward speed and angle of downwind VMG on starboard tack in the selected day are displayed.

To the lower right in the drawing, “Speed” 2041, “Total Speed” 2042, “Direction” 2043, and “Total Direction” 2044 concerning upward speed and angle of downwind VMG on port tack in the selected day are displayed.

A line 2004 represents a polar curve of the selected day while a line 2005 represents a polar curve based on the overall data. An arrow 2006 indicates a vector of record top velocity. An arrow 2015 indicates a vector of the upwind VMG on starboard tack in the selected day, and an arrow 2016 indicates a vector of the overall upwind VMG on starboard tack. The length of each arrow indicates speed while the direction of the arrow indicates the angle.

Similarly, an arrow 2025 indicates a vector of the upwind VMG on port tack in the selected day, and an arrow 2026 indicates a vector of the overall upwind VMG on port tack. An arrow 2035 indicates a vector of the downwind VMG on starboard tack in the selected day, and an arrow 2036 indicates a vector of the overall downwind VMG on starboard tack. An arrow 2045 indicates a vector at the downwind VMG on port tack in the selected day, and an arrow 2046 indicates a vector at the overall downwind VMG on port tack.

The thus-configured map screen is usefully referred to, in order to understand the characteristics of the rider's sailing method (habits and what the rider is good at or poor at) in relation to the wind direction.

The “Active Days” 1701, “Total Distance” 1702, “Your Best Top” 1703 in the upper field of the display screen represent the same contents as those of FIGS. 17 to 19. The daily data list 1721 including summary and the list 1722 including summary of the plural Practice sessions in the daily data, which are displayed in the left field of the display screen, are the same as those in FIGS. 17 to 19.

The screen change buttons displayed in upper part of the main field of the display screen, including the “Summary” button 1751, “Map” button 1752, and “Polar Diagram” button 1753 are the same as those in FIGS. 17 to 19. In FIG. 20, since the polar diagram is displayed, the display style (including colors) of the “Polar Diagram” button 1753 is different from that of the “Summary” button 1751 and “Map” button 1752.

As described above, a polar curve is drawn based on the information (speed, direction) acquired by the GPS, and what kind of tool the rider used and how the rider sailed are recorded.

While conventional GPS products provide only comparisons of the maximum speed and average speed, visualization in the map display enables visual and objective evaluation of the sailing ability. This allows the user to understand the factors for improvements. The VMG and top speed are thereby improved in the situation of the same tool and same wind velocity, for example. In addition, the user confirms that the sailing method is improved. The VMG and top speed are improved at the same sailing method and the same wind velocity, for example. Furthermore, the user confirms improvements by the tool.

(Application Example 1 of Map Display)

FIG. 21 is an application example of the display screen illustrated in FIG. 18, representing a display when one leg is selected. In FIG. 21, the selected date, practice, and leg are displayed in “Dates”, “Practices”, and “Legs” in the left field of the display screen, respectively.

In FIG. 21, a speed display section 2102 displays change with time in speed in the selected leg through a line graph. The speed display section 2102 displays a replay position bar 2103.

As the replay position bar 2103 moves, an arrow point 2104 in the map section 2101 moves in synchronization with the replay position. In other words, the arrow point 2104 indicates the location of the sailboard 110 at the time (“13:47:37”) corresponding to the replay position. Displaying the replay position bar 2103 and arrow point 2104 in the same color (red, for example) increases the feeling of synchronization.

The display screen includes a “Port/Starboard” display section 2105 in upper part of the right field. The “Port/Starboard” display section 2105 displays any one of “Port” and “Starboard”.

Under the display section 2105, images of a whole model of the sailboard 110 seen at three different angles are displayed. An image 2106 is an image of the front view of the sailboard 110, representing a model 2111 of the sailboard 110. The model 2111 is displayed with the inclination controlled based on the roll angle around the joint 112 (the joint between the mast 111 and board 115). The user thereby confirms the lateral inclination of the mast 111. The image changes as the replay position bar 2103 moves. This allows the user to readily and definitely understand the relationship between the speed and the lateral position (kite amount (roll angle)) of the mast 111.

The image 2106 includes a circular scale 2112 indicating angle. The scale 2112 indicates the lateral angle of the mast 111 in accordance with the replay position bar 2103. The right end of the scale 2112 is 90 degrees while the left end is −90 degrees. This allows the user to institutively understand the motion of the mast 111 and the like.

An image 2107 is an image of a side view of the sailboard 110, representing a model 2113 of the sailboard 110. The model 2113 is displayed with an inclination controlled based on the pitch angle around the joint 112 (the joint between the mast 111 and board 115). The user thereby confirms the longitudinal inclination of the mast 111.

The image 2107 may be an image seen from the other side. The images may be both displayed simultaneously or switched by tapping. The image changes as the replay position bar 2103 moves. This allows the user to readily and definitely understand the relationship between the speed and the longitudinal position (aft-rake angle (pitch angle)) of the mast 111.

The image 2107 includes a circular scale 2114 similar to the scale 2112 around the model 2113. The pointer of the scale 2114 moves right and left so as to indicate the longitudinal angle of the mast 111 in accordance with the replay position bar 2103. The right end of the scale 2114 is 90 degrees while the left end is −90 degrees. This allows the user to institutively understand the motion of the mast 111 and the like.

An image 2108 is an image of the top view thereof (seen from above), illustrating a model 2115 of the sailboard 110. The model 2115 is displayed with the rotation controlled based on the yaw angle around the joint 112 (the joint between the mast 111 and board 115). The user thereby checks pull of the sail 113. The image changes as the replay position bar 2103 moves. This allows the user to readily and definitely understand the relationship between the speed and the rotational position (pull (yaw angle)) of the sail 113.

The image 2108 includes a circular scale 2116 similar to the scales 2112 and 2114 around the model 2115. The scale 2116 is a scale indicating an angle of 0 to 360 degrees unlike the scales 2112 and 2114. An arrow in the scale 2116 rotates to indicate the rotational angle of the sail 113 in accordance with the replay position bar 2103. This allows the user to institutively understand the motion of the mast 111 and the like.

The three images 2106 to 2108 are displayed next to one another simultaneously to facilitate confirming points to be checked. These three images 2106 to 2108 are configured to move in cooperation with elapsed time.

In such a manner, it is possible to numerically and visually confirm fluctuating motions of the mast 111 in the lateral and longitudinal directions. It is also possible to numerically and visually confirm fluctuating pull of the sail 113. This allows the user to objectively confirm which form the rider took on the sailboard 110. In addition, the visual representation using such a 3-D model, instead of numerical representation, allows the rider or others to understand the form more clearly.

The sailing form (to be precise, the state of the tool is formed based on the human's form) is conventionally confirmed just by taking pictures with a camera. Such a conventional method does not have a means to confirm the sailing form from the front, side, back, and top simultaneously and does not provide numerical information about the form. Visual and numerical confirmation from the front, side, back, and top of the sailboard using the map display allows the user to create a guideline how to improve the sailing method and a numerical guideline to improve the same.

(Application Example 2 of Map Display)

FIG. 22 is another application example of the display screen illustrated in FIG. 18. In FIG. 22, a circular direction display section 2201 is displayed in upper central part of the display screen. Below the direction display section 2201, a speed display section 2202 is displayed. In the speed display section 2202, change in speed with time, of a selected leg is displayed through a line graph 2210. The line graph 2210 may be colored in accordance with the upward angle (described in detail later).

Under the speed display section 2202, a play button 2203, a fast-forward button 2204, and a rewind button 2205 are displayed. The speed display section 2202 includes a replay position bar 2206. Under the replay position bar 2206, time (“00:00:33”) at the replay position is displayed.

In the left field of the display screen, a “Legs” list 2250 is displayed in addition to the list 1721 (“Dates”) and list 1722 (“Practices”). When one of the Practice sessions in the list 1722 is selected, a list of plural legs of the selected Practice session is displayed as the list 2250. Selecting one of the legs gives the display screen illustrated in FIG. 22. FIG. 22 illustrates the state where the leg of No. 1 is selected.

The three images 2106, 2107, and 2108 in the right field of the display screen are the same as those in FIG. 21, and the description thereof is omitted.

When the replay button 2203 is pressed, the replay position bar 2206 automatically moves from left to right. The speed of the replay position bar 2206 may be configured to correspond to the recording time, to be double the recording time, or to slow down. The replay operation may be paused when the replay button 2203 is pressed again during the replay operation. In such a manner, the user instructs replay in the same manner as operation for DVD players, for example.

The displayed log is replayed in such a manner. Because of the automatic replay, the user (the rider) replays the log just by pressing the replay button 2203, without performing any other operations. The user therefore focuses on understanding the displayed contents (tracing of sailing) while holding an image of actually sailing across the wind.

(Contents of Direction Display Section 2201)

Next, a description is given of the contents of the circular direction display section 2201. The direction display section 2201 in FIG. 22 is circular and indicates a cardinal direction in 360 degrees. The north (N) is at 12, and a VMG region 2211 is represented at about 45 degrees in the west on the circumference. In FIG. 22, the VMG region 2211 has an angular width of about 10 degrees. The angular width is freely determined by the user.

The direction indicated by the VMG region 2211 may be a travel direction of the sailboard 110 or may be a sail angle of the sailboard 110. The direction indicated by the VMG region may be switched between the same by user's setting. A pointer 2212 indicates the travel direction or the sail angle of the sailboard 110 in accordance with the direction indicated by the VMG region 2211.

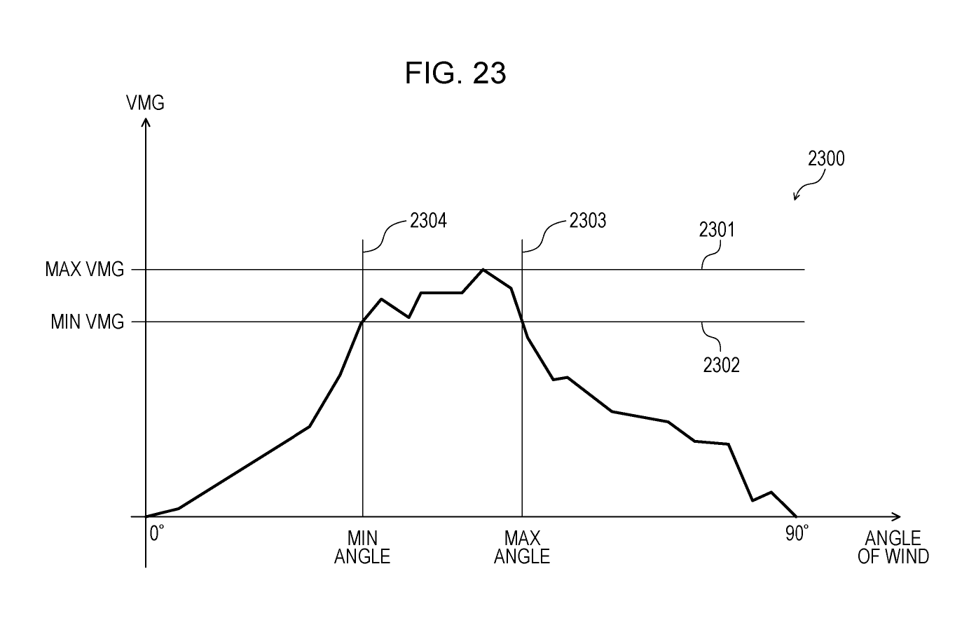

The recommended movement direction or recommended sail direction is represented with an angle of a range corresponding to VMG values from a maximum VMG value 2301 to a predetermined ratio of the maximum VMG value 2301. In this range, the density of color varies depending on the magnitude of the VMG value. The specific method is performed in the following manner as illustrated in FIG. 23.

FIG. 23 is an explanatory view (graph) illustrating how to determine the width and color of the VMG region. In a graph 2300 in FIG. 23, the vertical axis represents VMG while the horizontal axis represents wind angle.

In the graph 2300, a range is set between a maximum angle (Max Angle) 2303 and a minimum angle (Min Angle) 2304 corresponding to the range between the maximum VMG value 2301 and a VMG value 2302, which is a predetermined ratio of the maximum VMG value 2301. Specifically, the predetermined ratio is freely determined by the user and is 20%, for example. The set range is the angular width of the VMG region 2211 in FIG. 22.

The area indicating the VMG region 2211 may be displayed in varying density of color depending on the magnitude of the VMG value, in the range between the maximum and minimum angles 2303 and 2304. Specifically, in the range between the maximum and minimum angles 2303 and 2304, the color density is determined based on the ratio of the VMG value to values from the maximum VMG value 2301 to the minimum VMG value 2302. As the VMG value comes closer to the maximum VMG value 2301, the density of color becomes higher. As the VMG value comes closer to the minimum VMG value 2302, the density of color becomes lower (lighter).

Coloring the VMG region 2211 in such a manner produces variations in density of color in the VMG region 2211 as illustrated in FIG. 22. This allows the user to determine that darker part is closer to the maximum VMG value while lighter part is away from the maximum VMG value. The user thereby institutively understands the direction at which the maximum VMG value was obtained depending on the density of color in the VMG region 2211.

A true wind display section 2213 is displayed on the same circumference. The true wind display section 2213 indicates that true wind is substantially from the northeast in FIG. 22. An apparent (or ostensible) wind display section 2214, which is displayed on the same circumference as the true wind display section 2213, indicates the direction (wind direction) of apparent wind calculated based on the true wind and the travel direction and speed of the sailboard 110. The apparent wind display section 2214 indicates that the apparent wind is substantially from the east northeast in FIG. 22.

The true wind is actual wind while the apparent wind is wind hitting the sailboard 110. The sailboard 110 normally moves at several tens kilometers per hour in a predetermined direction. The direction of wind hitting the sailboard 110 is different from that of true wind due to the movement. The wind in the different direction is referred to as apparent wind. The apparent wind is calculated by taking an account of the movement direction and speed of the sailboard 110 in relation to the true wind. The rider of the sailboard 110 steers the sailboard 110 so as to maximize the VMG value with reference to the direction of apparent wind that the rider actually experiences and the movement direction and speed of the sailboard 110.

The direction display section 2201 simultaneously displays the VMG region 2211, true wind display section 2213, and apparent wind display section 2214 on the same circumference. This allows the user to institutively understand the relationship between the VMG and the true wind and apparent wind.

The direction display section 2201 may display reference lines 2215 at every 90 degrees based on the position of the apparent wind display section 2214. This allows the user to easily understand the angle of the VMG region 2211 based on the direction of the apparent wind.

(Contents of Speed Display Section 2202)

Next, a description is given of the contents of the speed display section 2202 represented by a line graph. In the speed display section 2202 of FIG. 22, the region surrounded by the line graph 2210 is colored, so that the user institutively understands the relationship between the speed and upward angle.

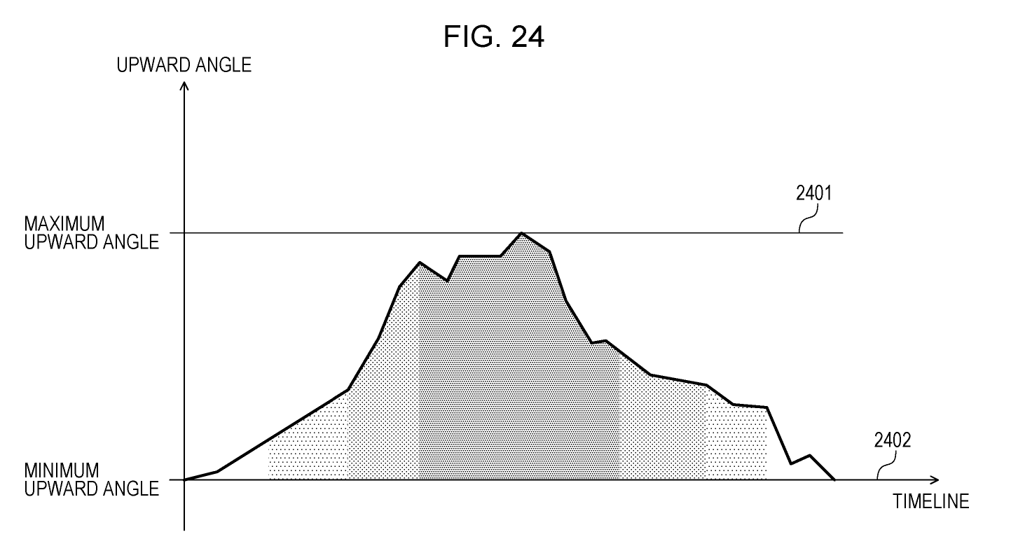

FIG. 24 is an explanatory view (graph) illustrating how to determine coloring of angle representation. FIG. 24 illustrates a maximum upward angle 2401 and a minimum upward angle 2402. Herein, between the maximum and minimum upward angles 2401 and 2402, the region surrounded by the line graph 2210 may be displayed with varying density of color depending on the ratio of the upward angle to the difference between the maximum and minimum upward angles 2401 and 2402.

Specifically, the density of color is determined as follows:

Percentage of color density=upward angle/(a)−(b)

where (a) and (b) are the maximum and minimum upward angles, respectively.

In the speed display section 2202 illustrated in FIG. 22, the region defined by the line graph 2210, that represents changes in speed with time, is represented (in yellow, for example) by a gradation in density of color. Based on the density of color, the user institutively understands the upward angle. Specifically, the user understands that the upward angle is larger when the color density is higher and the upward angle is smaller when the density of color is lower.

As described above, in the embodiment, the information processing apparatus 103 acquires the wind direction information representing the measured wind direction around the sailboard 110 and calculates the movement direction and speed of the sailboard 110 based on the outputs from the position measurement sensor of the sailboard 110. With reference to the database 102, which stores the wind direction measured in the past movements of the sailboard 110 and the movement direction and speed of the sailboard 110, the information processing apparatus 103 specifies the recommended movement direction or recommended sail direction of the sailboard 110. The information processing apparatus 103 then transmits the specified recommended movement direction or recommended sail direction to the steering assist apparatus 104. In the steering assist apparatus 104, the recommended movement direction or recommended sail direction is confirmed. This assists efficient steering and sailing of the user.

In the embodiment, the information processing apparatus 103 receives the position measured by the position measurement sensor mounted on the sailboard 110 or the movement direction and speed of the sailboard 110, which are calculated based on the measured position. With reference to the storage that stores the movement history of the sailboard 110 and the wind direction information around the sailboard 110, the information processing apparatus 103 calculates the recommended movement direction or recommended sail direction of the sailboard 110. The steering assist apparatus 104 receives from the information processing apparatus 103, the recommended movement direction or recommended sail direction of the sailboard 110 and outputs the received recommended movement direction or recommended sail direction through displays or sounds. The user thereby confirms efficient steering and sailing.

In the embodiment, the recommended movement direction or recommended sail direction is represented with an angle of a range from the maximum angle 2303 and the minimum angle 2304 corresponding to the maximum VMG value 2301 and the VMG value 2302, which is a predetermined ratio of the maximum VMG value 2301. The user (rider) thereby confirms proper steering and sailing for own VMG values.

In the embodiment, the VMG value is displayed with varying density of color depending on the magnitude of the VMG value in the range from the maximum to minimum angles 2303 to 2304. The user thereby institutively understands the magnitude of the VMG value.

In the embodiment, the circular FIG. 2201 is displayed, and the recommended movement direction or recommended sail direction is displayed along the circumference of the circular FIG. 2201. The user thereby clearly understands the recommended movement direction or recommended sail direction.

In the embodiment, the steering assist apparatus 104 receives the wind direction around the sailboard 110 from the information processing apparatus 103 and displays the received wind direction (true wind direction) in comparison with the recommended movement direction or recommended sail direction. The user thereby visually confirms the direction of true wind. In this process, the recommended movement direction or recommended sail direction are displayed along the circumference of the circular figure while the true wind direction is displayed along the circumference of the same figure. The user thereby easily compares the recommended movement direction or recommended sail direction with the apparent wind direction.

In the embodiment, the steering assist apparatus 104 receives from the information processing apparatus 103, the wind direction around the sailboard 110 and the apparent wind direction calculated based on the movement direction and speed of the sailboard 110 and displays the received apparent wind direction in comparison with the recommended movement direction or recommended sail direction. The user thereby visually confirms the apparent wind direction. In this process, the recommended movement direction or recommended sail direction are displayed along the circumference of the circular figure while the apparent wind direction is displayed along the circumference of the same figure. The user thereby easily compares the recommended movement direction or recommended sail direction with the apparent wind direction.

In the embodiment, the steering assist apparatus 104 receives the movement speed from the information processing apparatus 103 and displays change with time in the movement speed through a graph. The steering assist apparatus 104 also displays the upward angle, between the maximum and minimum upward angles 2401 to 2402, in the graph with varying density of color depending on the ratio of the upward angle to the difference between the maximum and minimum upward angles. The user thereby easily understands the upward angle in relation to change with time in movement speed.

Such a configuration allows the user to visually confirm the speed, travel direction, the relationship with the location on the map, sailing state (especially sail stability, specifically, whether optimal sail angle is kept) and quantify the sailing form. It is therefore possible to create an optimal form model based on the obtained data. In addition, it is possible to determine what is recommended fast sailing method based on the VMG as the ability criterion. It is therefore possible to assist efficient steering and sailing, improving the steering skills of the sailboard, such as a windsurfing board.

The embodiment is described using the windsurfing board as a moving body which moves by wind. However, the disclosure is not limited to the aforementioned embodiment and may be applied to a sailing body, such as a yacht. The disclosure is not limited to a body moving on a body of water and may be a body moving on the ground.

The steering assist method described in the embodiment is implemented by causing a computer, such as a personal computer or a work station, to execute programs prepared in advance. The steering assist program is recorded in a computer-readable recording medium, such as a hard disk, a flexible disk, a compact disc (CD-ROM), a magneto-optical disk (MO), a digital versatile disk (DVD), or a Universal Serial Bus (USB) memory and is loaded by the computer from the recording medium to be executed. The steering assist program may be distributed through a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a steering assist program that causes a computer to execute a process comprising:
acquiring wind direction information representing the measured wind direction around a sailboard;
calculating a movement direction and a movement speed of the sailboard based on an output of a position measurement sensor of the sailboard;
specifying a recommended movement direction or a recommended sail direction of the sailboard by referring to a storage storing the wind direction, the movement direction and the movement speed of the sailboard measured during past movements of the sailboard; and
transmitting the specified recommended movement direction or the recommended sail direction to a steering assist apparatus of the sailboard.

2. A non-transitory computer-readable storage medium storing a steering assist program that causes a computer to execute a process comprising:
receiving a recommended movement direction or a recommended sail direction from an information processing apparatus which receives a position measured by a position measurement sensor mounted on a sailboard or a movement direction and a movement speed of the sailboard calculated based on the measured position, and calculates the recommended movement direction or the recommended sail direction of the sailboard by referring to a storage that stores a movement history of the sailboard and past wind direction information around the sailboard, and
outputting the received recommended movement direction or the recommended sail direction, through displays or sounds.

3. The storage medium according to claim 2, wherein the recommended movement direction or the recommended sail direction is displayed with a range of angle corresponding to VMG (velocity made good) values from a maximum VMG to a predetermined ratio of the maximum VMG.

4. The storage medium according to claim 3, wherein
in the range, the VMG value is displayed with varying density of color depending on the magnitude of the VMG value.

5. The storage medium according to claim 2, the process further comprising:
displaying a circular figure, wherein
the recommended movement direction or the recommended sail direction is displayed along the circumference of the circular figure.

6. The storage medium according to claim 2, the process further comprising:
receiving a wind direction around the sailboard from the information processing apparatus; and
outputting the received wind direction in comparison with the recommended movement direction or the recommended sail direction through displays.

7. The storage medium according to claim 6, the process further comprising:
displaying a circular figure, wherein
the recommended movement direction or the recommended sail direction is displayed along the circumference of the circular figure, and
the wind direction is displayed along the circumference of the same circular figure.

8. The storage medium according to claim 2, the processes further comprising:
receiving, from the information processing apparatus, an ostensible wind direction calculated based on a wind direction around the sailboard and the movement direction and movement speed of the sailboard; and
outputting the received ostensible wind direction in comparison with the recommended movement direction or the recommended sail direction through displays.

9. The storage medium according to claim 8, the process further comprising:
displaying a circular figure, wherein
the recommended movement direction or the recommended sail direction is displayed along the circumference of the circular figure, and
the ostensible wind direction is displayed along the circumference of the same circular figure.

10. The storage medium according to claim 2, the process further comprising:
receiving the movement speed from the information processing apparatus;
displaying a change with time of the movement speed in the form of a graph; and
varying density of color of the graph depending on the maximum and minimum upward angles.

11. A steering assist apparatus comprising:
a memory, and
a processor coupled to the memory and configured to perform a process comprising:
receiving a recommended movement direction or a recommended sail direction from an information processing apparatus which receives a position measured by a position measurement sensor mounted on a sailboard or a movement direction and a movement speed of the sailboard calculated based on the measured position and calculates the recommended movement direction or the recommended sail direction of the sailboard by referencing to a storage that stores a movement history of the sailboard and past wind direction information around the sailboard, and
outputting the received recommended movement direction or the recommended sail direction, through displays or sounds.

12. An information processing apparatus comprising:
a memory, and
a processor coupled to the memory and configured to perform a process comprising:
acquiring wind direction information representing the measured wind direction around a sailboard;
calculating a movement direction and movement speed of the sailboard based on an output of a position measurement sensor of the sailboard;
specifying a recommended movement direction or recommended sail direction of the sailboard by referencing to a storage storing the wind direction, the movement direction and movement speed of the sailboard measured during past movements of the sailboard; and
transmit the specified recommended movement direction or the recommended sail direction to a steering assist apparatus of the sailboard.

13. The storage medium according to claim 1, wherein the recommended movement direction or the recommended sail direction is based on a range of angle corresponding to VMG (velocity made good) values from a maximum VMG to a predetermined ratio of the maximum VMG.

14. The steering assist apparatus according to claim 11, wherein the recommended movement direction or the recommended sail direction is based on a range of angle corresponding to VMG (velocity made good) values from a maximum VMG to a predetermined ratio of the maximum VMG.

15. The steering assist apparatus according to claim 12, wherein the recommended movement direction or the recommended sail direction is based on a range of angle corresponding to VMG (velocity made good) values from a maximum VMG to a predetermined ratio of the maximum VMG.
